(19) United States
(12) Patent Application Publication
(10) Pub. No.: US 2009/0063173 A1
(43) Pub. Date: Mar. 5, 2009

(54) Subject Matter Management System 'SMMS'

(76) Inventors: David Chen Yu, Laguna Niguel, CA (US); Larry Marston, Temple City, CA (US)

Correspondence Address: WILSON DANIEL SWAYZE, JR., 3804 CLEARWATER CT., PLANO, TX, 75025, US

(21) Appl. No.: 11/847,988

(22) Filed: Aug. 30, 2007

(51) Int. Cl. G06Q 10/00

(52) U.S. Cl. 705/1

(57) ABSTRACT

An subject matter management system includes InFoDoc records adapted to be formed in a multitude of formats; a InFoDoc file to accept the InFoDoc records, Followup messages based on an InFoDoc record to be stored in a Followup file and a hierarchical system of access control to manage the integrity of the records.

### BACKGROUND OF THE INVENTION

Disputes and resolution of disputes are usually dependent on evidences presented. Other than oral evidence, other evidences are documents and records from the parties.

Documental and other physical evidences can refresh witnesses' memories; offer support to oral testimonies or to debunk the opponent. A defending company is at a great disadvantage if it failed to locate the proper physical evidence. On the other hand, its case will be greatly enhanced if it has all the proper evidence at hand.

Companies are also required to pass judgment each day based on information and documents incurred on various matters. Examples of these judgments are customer sales and services disputes, employment promotions and terminations, and many other management decisions.

A company can manage, follow-up and enforce compliance in its many business projects, in its day-to-day operations and processes, in its many dealings with outside parties, such as customers and/or government agencies, in its various departments especially in its human resource department through the management of all the pieces of information, documents and communications that incurred each day.

These information, documents and communications collected (‘InFoDoc’) must be inputted in certain formats to confirm with preset protocols in order to elicit the proper responses, must be arranged in certain orders to facilitate retrievals and a system of access authorities for users must be established to limit these retrievals from unauthorized uses. These records must also be reasonably protected from alterations and deletions to engender user trust.

### SUMMARY OF THE INVENTION

Subject Matter Management System (‘SMMS’) is build for the collection of information on subject matters and to chronicle the enforcement of policies relating to those subject matters.

The trustworthiness of a system depends on a large part on the system's policies on its record integrity against record alterations, deletions and unauthorized accesses. SMMS offers controlled accesses based on common corporate staff hierarchy structure (see A Hierarchy of Control in FIG. 100A & FIG. 100B). Also, in most areas of SMMS, audit trails are recorded for each alteration.

Within SMMS (see FIG. 101), InFoDoc and its Followups are the records that stores the information, refers to and links with relevant documents and activates communications and links with the resulting files. The idea, matter, event, question, accusation, inquiry, etc . . . that is the subject of the discussion is contained in the Subject Matter field of the InFoDoc.

As is true with any disputes, discussions would invite further discussions. In SMMS, further discussions on the Subject Matter can be conducted in the Followup records, which allow cross consultations with third parties and private notes.

To be useful, all InFoDoc records must be arranged in certain orders. The most prominent of these orders is to segregate them by where they belong to such as by the Departments, then the Work Functions within the Departments, then the Issue Name which further defines the divisions within the Work Function, i.e. duties, projects, requirements, etc . . . Version Number is used to distinguish the different version of the Issue. The Area of Concern can be used to further divide up a Version into sections of area of concern.

InFoDoc records can be created by many methods, among them Manual Entry is used to create a record on one Subject Matter between two parties, SMMS Library Programs are used to create a single or a batch of InFoDoc records on one Subject Matter targeting one or many Recipient Parties who are a segment of the population in the SMMS, the communications pertaining to Licensing and Continuing Educations are created manually in InFoDoc and is linked to one license or one Continuing Education requirement for a Salesperson or Staff. Supervisory and System Messages are created by SMMS systematically (see FIGS. 102A, 102B and 102C).

In order to solicit proper response, all InFoDoc record entries are required to conform to certain formats, such as whether it is a Question/Answer, Survey/Appraisal, Notice/Acknowledgement, Contract/Agreement, Discussion/Meeting Minutes or Private Note (see FIGS. 103A and 103B).

Each InFoDoc has a Sender and a Recipient Party and the party of the subject under discussion, the Targeted Party (see FIGS. 104A and 104B).

To enhance the efficiency of SMMS in a highly active office, Alert levels and related Back Office Decisions can provide the primary mean to sort the priority of each InFoDoc record ranged by whether the user is a Sender, Recipient or Targeted party within the sorting order of Department, Work Function, Issue, Version and Area of Concern (see FIGS. 105A and 105B).

The organization of these InFoDocs and their followups can be sorted and filtered by various elements aside from the Department, Work Function . . . sorting order as offered by the data base program from which ComRec was built. Therefore, browse, form presentations and reports are numerous, and new ones can be generated as required. SMMS is a part of ComRec.

Superiors can perform an ad hoc or impromptu review of SMMS. These reviews or examinations are usually triggered by an investigation of an employee, a complaint by a customer or by a legal action. Periodic reviews can be scheduled on exceptions such as excessive late answering and high Alert levels. It can also be triggered by Human Resources department's staff wanting to generate basic performance data in an employee review. Documents and reports of records can be generated to satisfy a legal subpoena or to complete a case history if demanded by certain audit.

SMMS is an enterprise management system, a system that is created in a data base management system. SMMS and the data files can be installed in a central server or in separate centralized servers, i.e. the application in one while the data is stored in another server.

The user client can access the SMMS through client stations if SMMS is running in a Client-Server mode or through a terminal if SMMS is running as a centralized server. Internet users can access the SMMS as a thin client similar to a remote terminal setup.

### BRIEF DESCRIPTION OF THE DRAWINGS

FIG. 100A and FIG. 100B illustrate the Hierarchy of Control;

FIG. 101 illustrates the SMMS Structure;

FIG. 102A illustrates the InFoDoc Propagate Programs;

FIG. 102B illustrates the SMMS Library Programs a subset of InFoDoc Propagate; Programs;

FIG. 102C illustrates the Followup Propagate Programs a subset of InFoDoc Propagate Programs;

FIG. 103A illustrates the InFoDoc—Form of Entry & Communication;

FIG. 103B illustrates the Followup—Form of Entry & Communication;

FIG. 104A illustrates the InFoDoc Parties;

FIG. 104B illustrates the Followup Parties;

FIGS. 105A and 105B illustrate the Additional Features of the SMMS;

FIGS. 107 to 138 illustrate various screen presentations of InFoDoc; and

FIGS. 140 to 156 illustrate various screen presentations of Followup.

### DETAILED DESCRIPTION

### A Hierarchy of Control

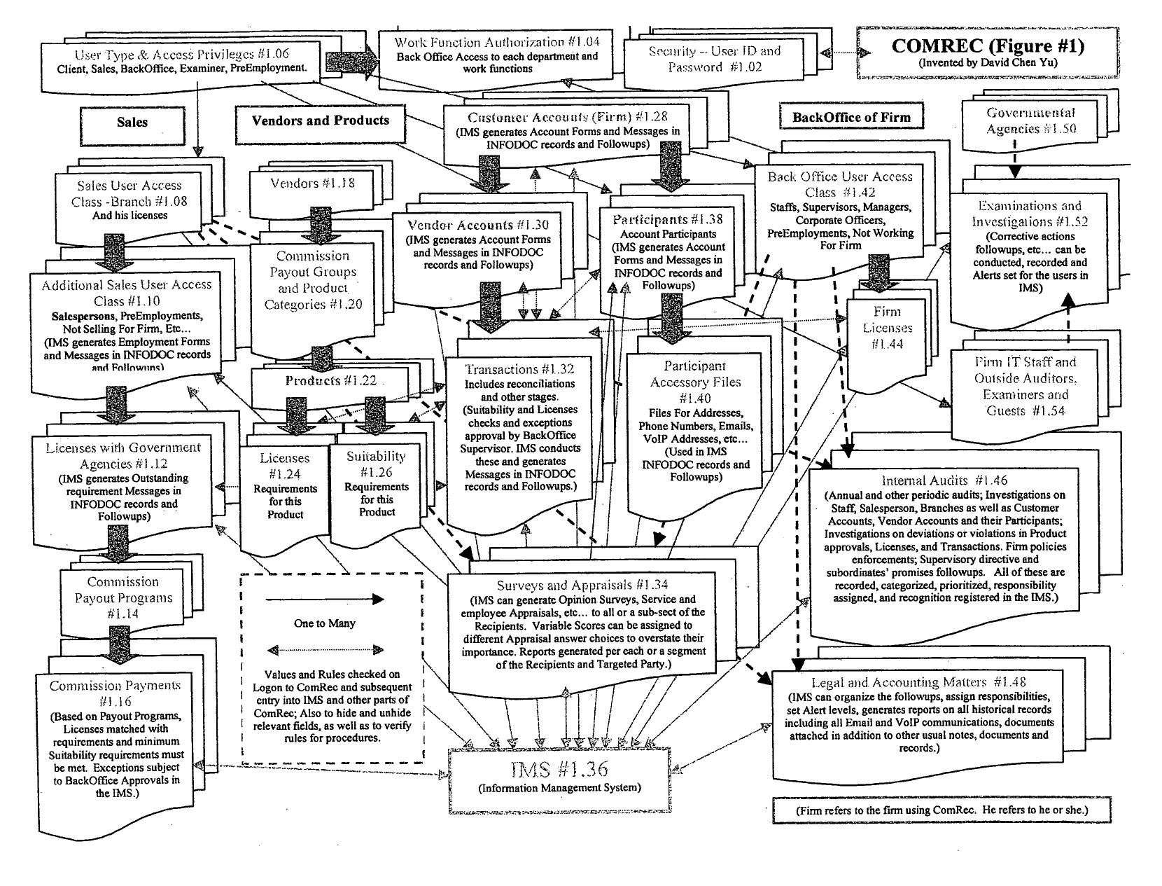

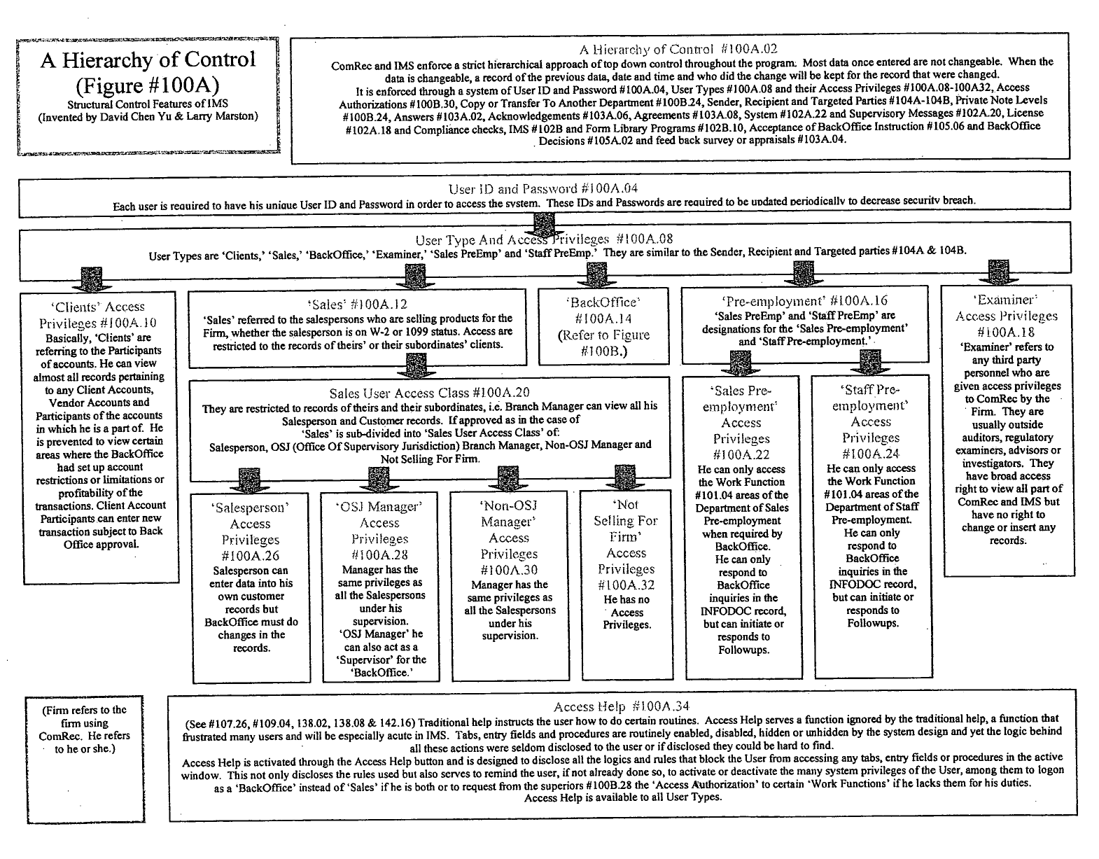

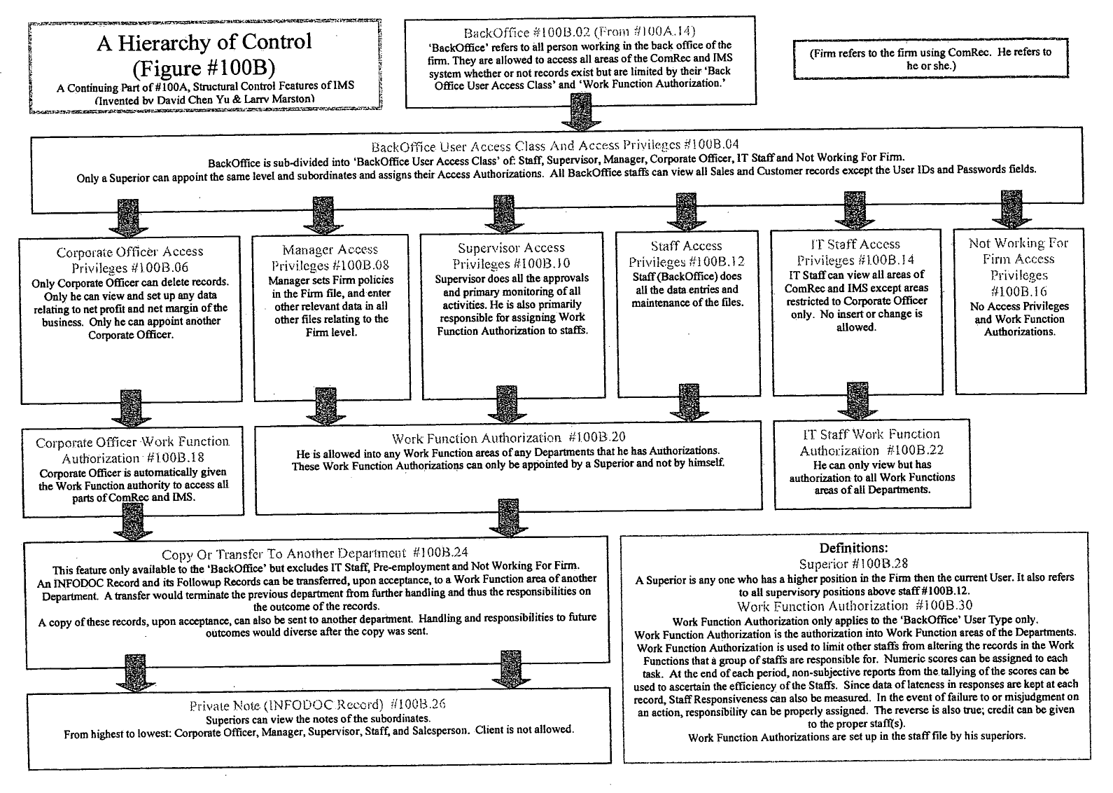

FIGS. 100A and 100B illustrate a structured access control for users based loosely on common corporate staff hierarchy organization and their relationship with third parties. ComRec and SMMS enforce a strict hierarchical approach of top down control throughout the program. Most data once entered are not changeable. When the data is changeable, a record of the previous data, date and time and who did the change will be kept for the record that was changed (A Hierarchy of Control, FIG. 100A.02).

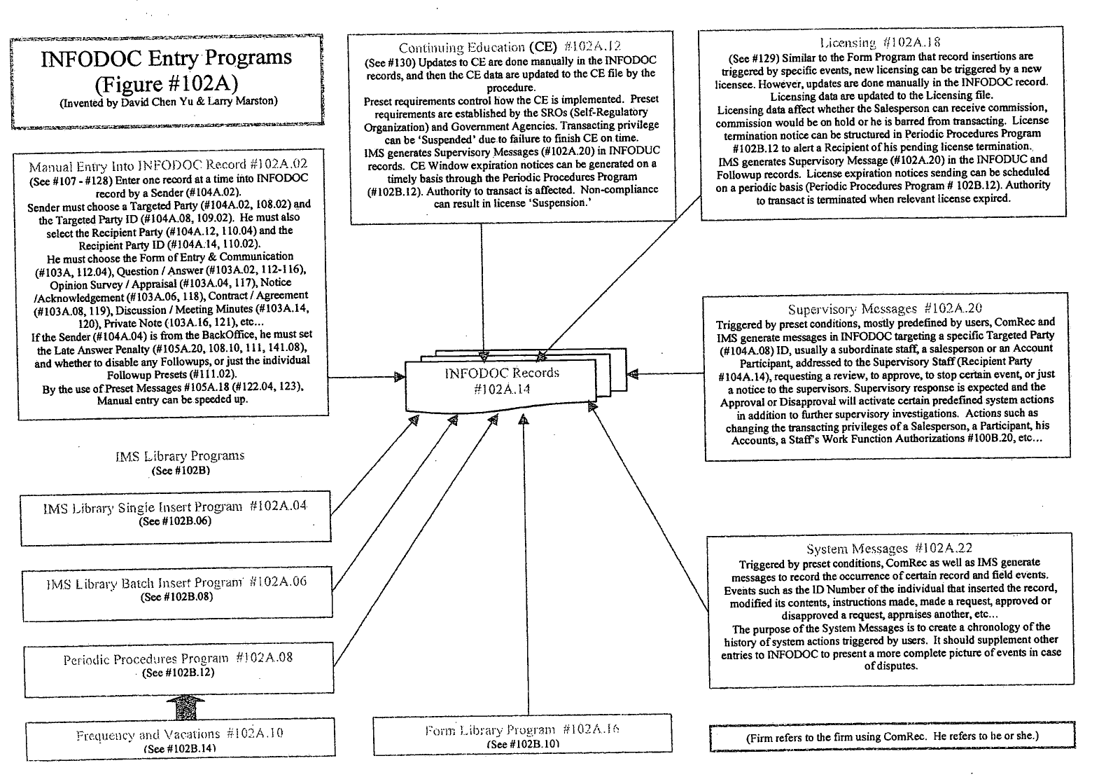

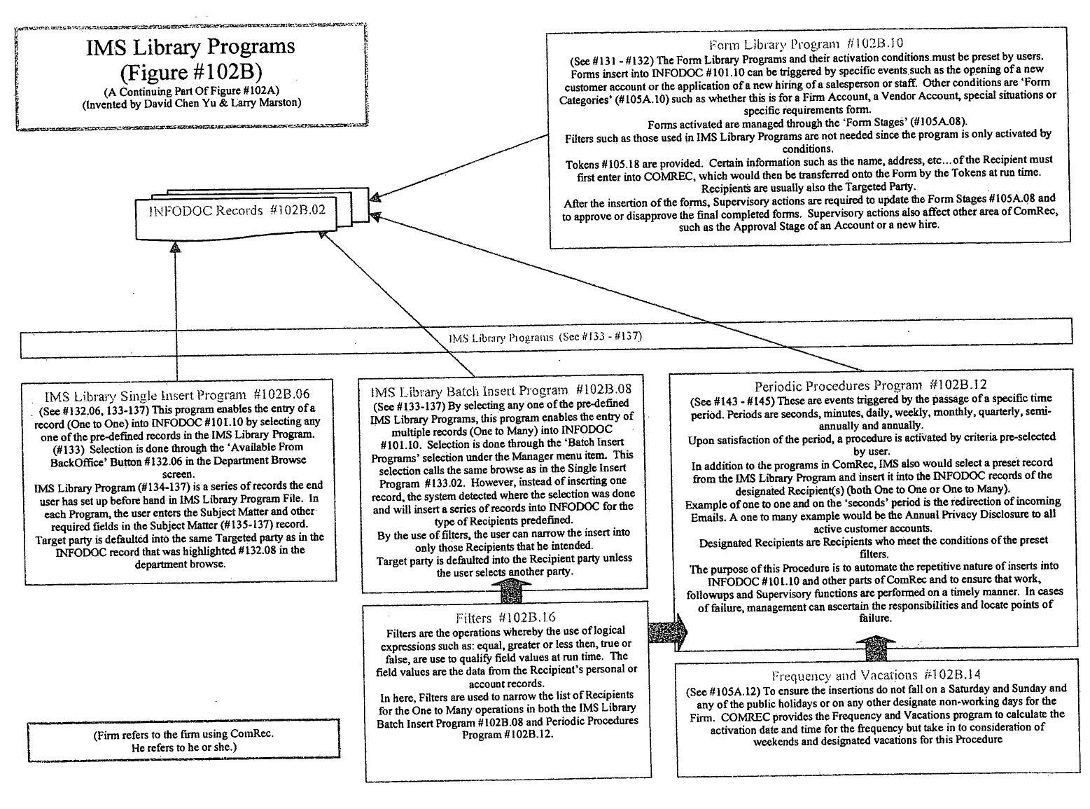

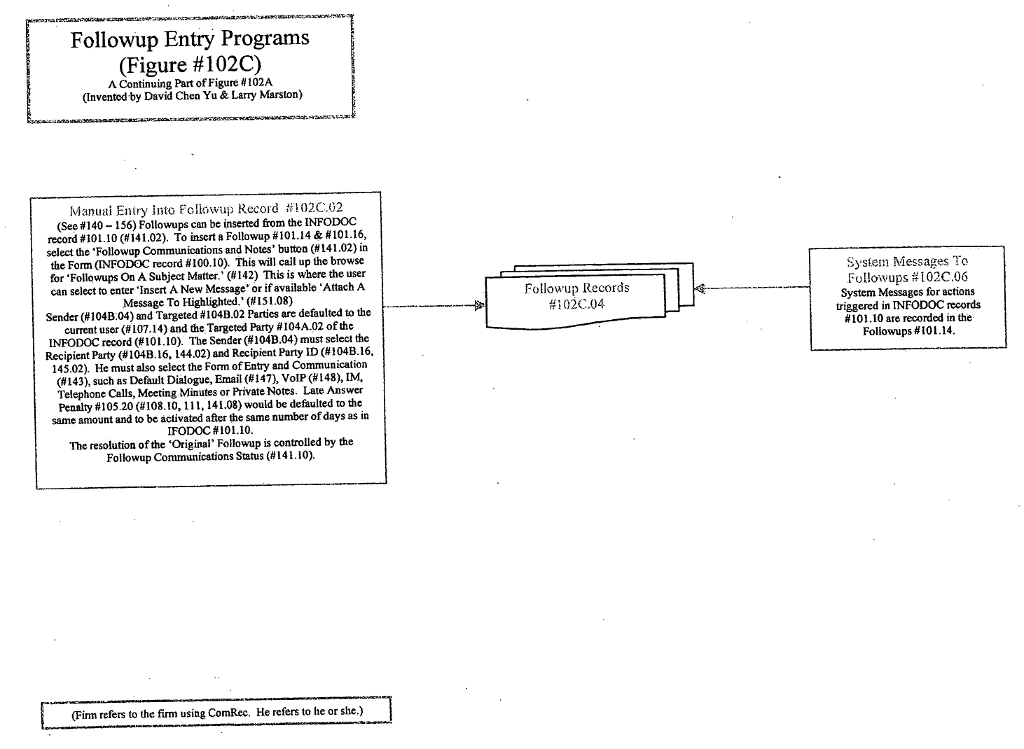

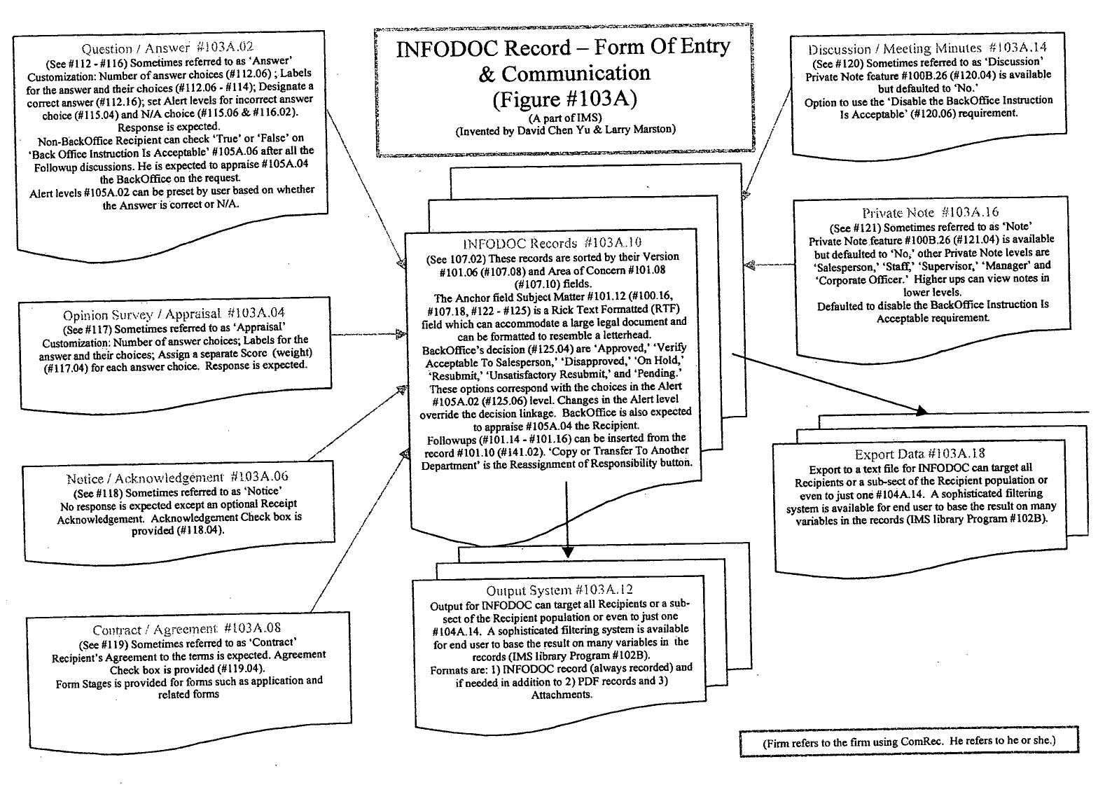

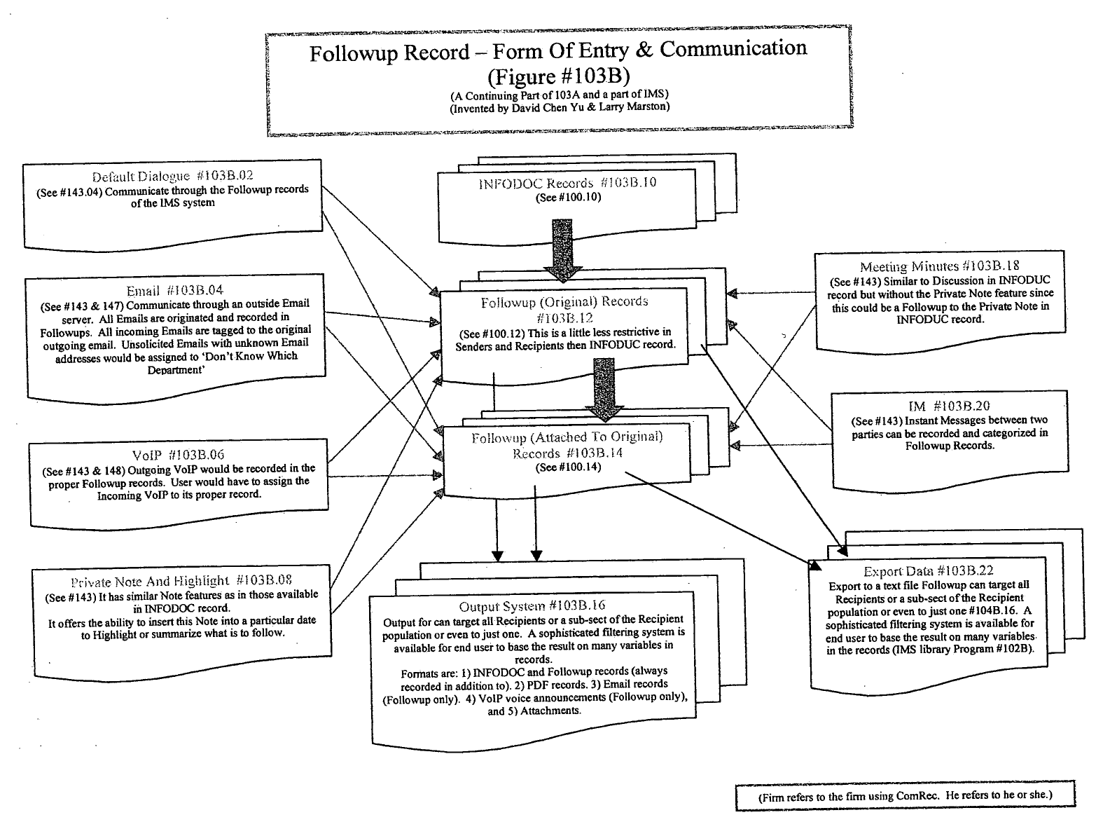

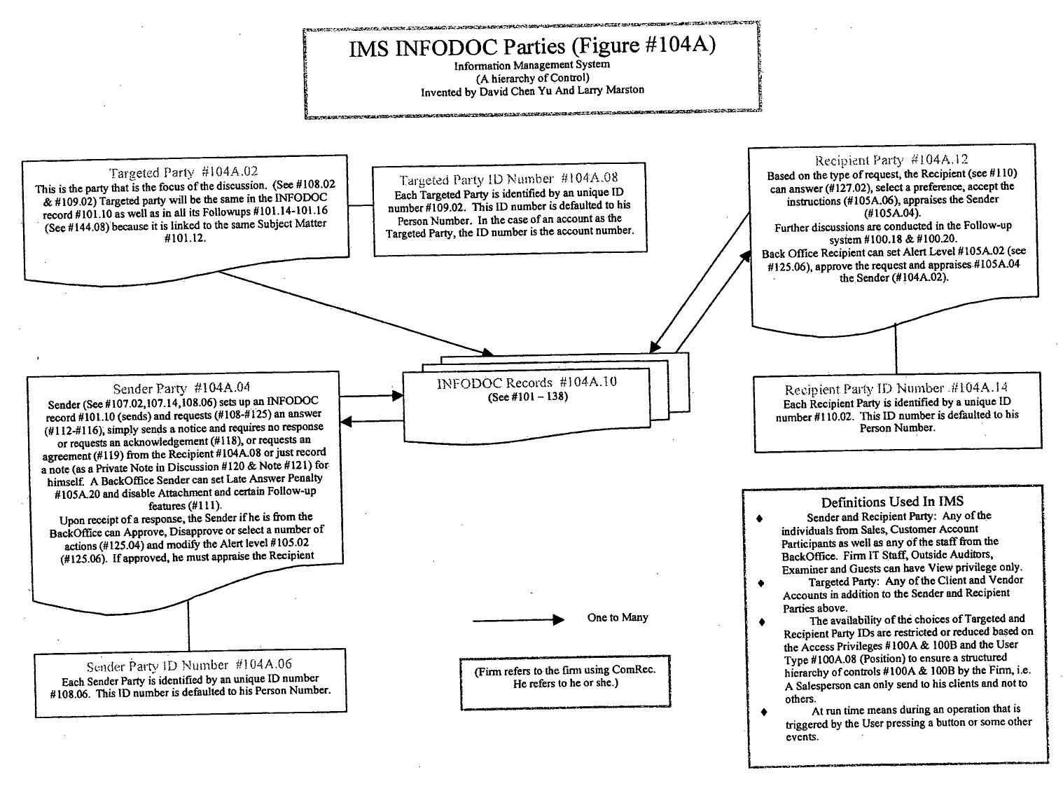

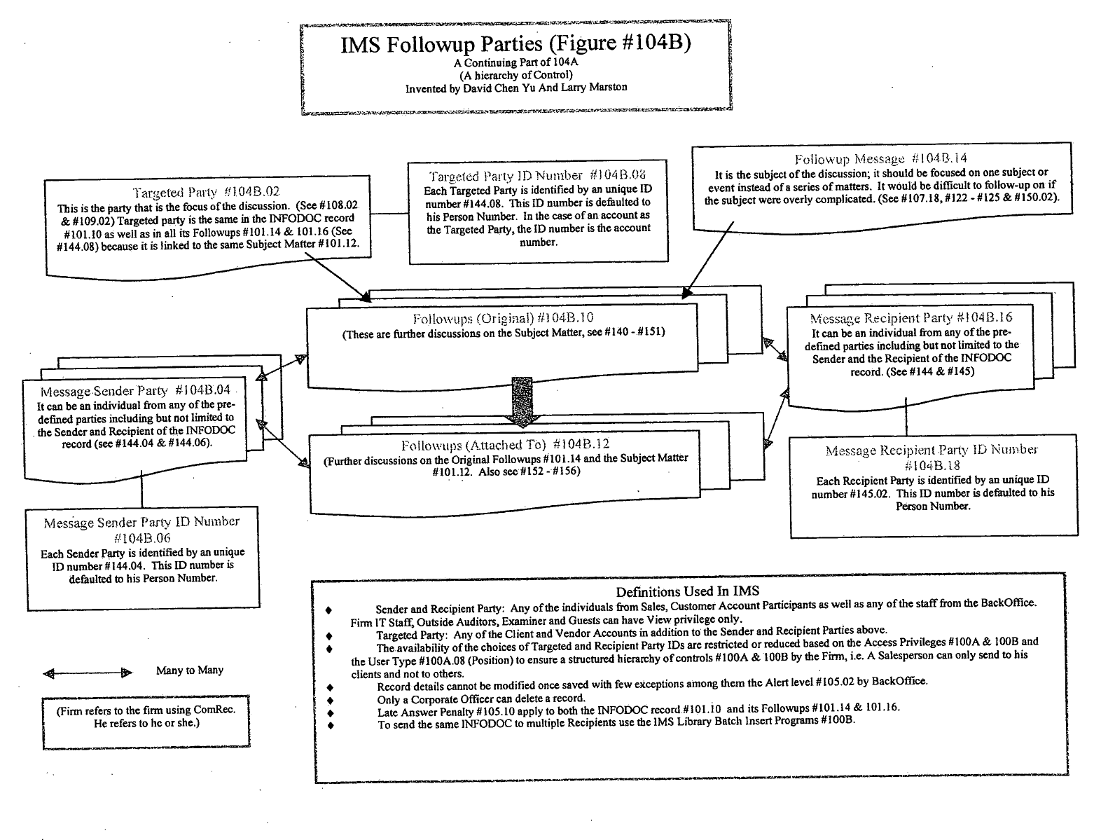

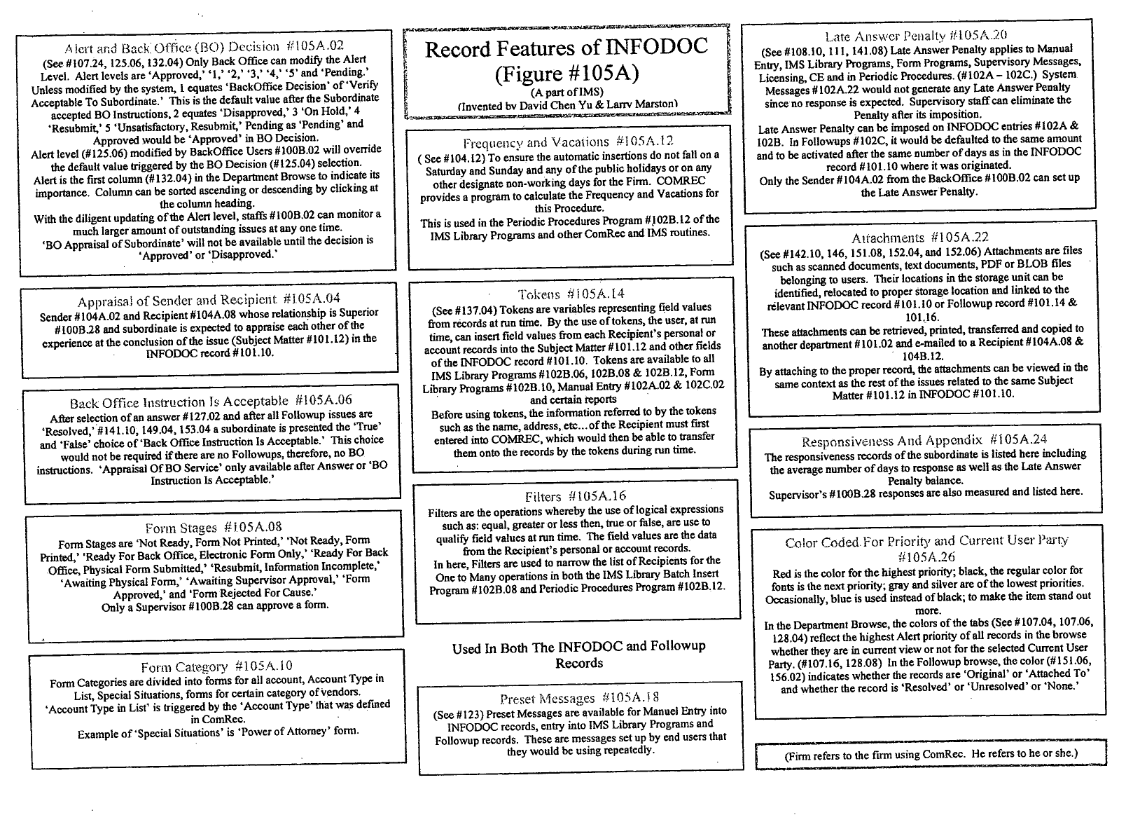

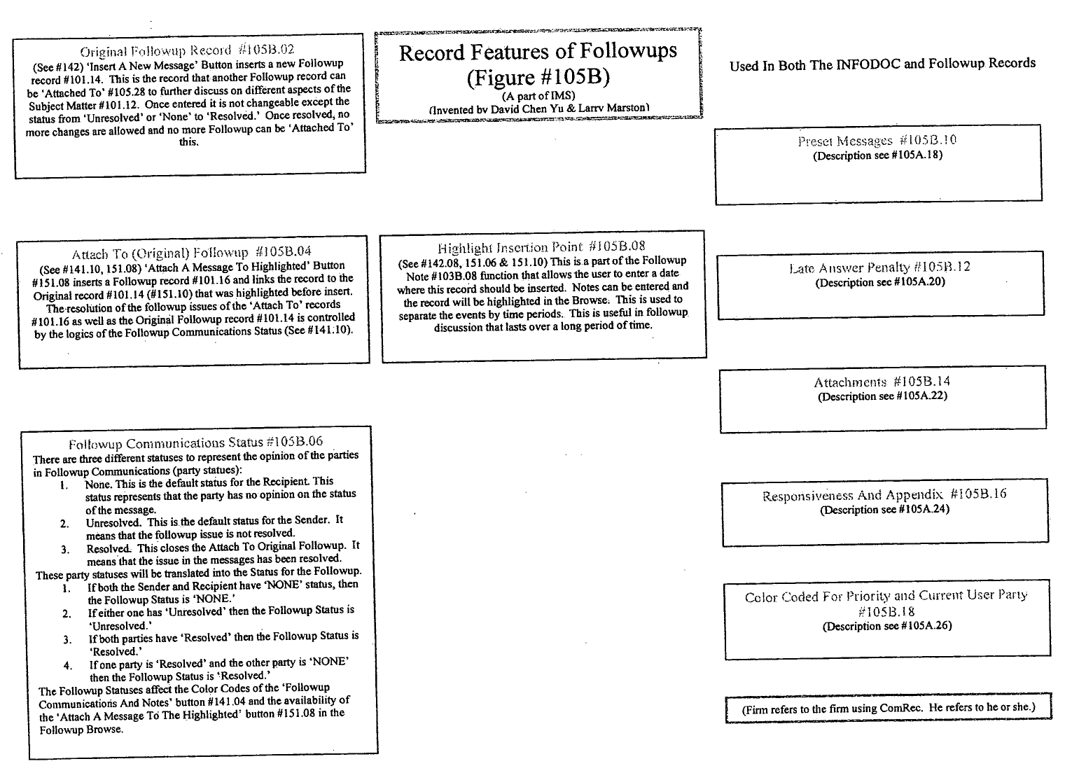

It is enforced through a system of User ID and Password (FIG. 100A.04), User Types (FIG. 100A.08) and their Access Privileges (FIG. 100A.08-100A32), Access Authorizations (FIG. 100B.30), Copy or Transfer To Another Department (FIG. 100B.24), Sender, Recipient and Targeted Parties (FIG. 104A-104B), Private Note Levels (FIG. 100B.24), Answers (FIG. 103A.02), Acknowledgements (FIG. 103A.06), Agreements (FIG. 103A.08), System (FIG. 102A.22) and Supervisory Messages (FIG. 102A.20), License (FIG. 102A.18) and Compliance checks, SMMS (FIG. 102B) and Form Library Programs (FIG. 102B.10), Acceptance of BackOffice Instruction (FIG. 105.06) and BackOffice Decisions (FIG. 105A.02), feed back survey or appraisals (FIG. 103A.04), etc . . .

### Detailed Description of a Hierarchy of Control

Each user is required to have his unique User ID and Password in order to access the system. These IDs and Passwords are required to be updated periodically to decrease security breach (See User ID and Password FIG. 100A.04).

### DEFINITIONS

### ‘Superior’ (FIG. 100B.28)

A ‘Superior’ is any one who has a higher position in the Firm (Firm is referring to the firm of the user) then the current User. It also refers to all supervisory positions above staff (FIG. 100B.12).

### Work Function Authorization (FIGS. 100B.20 and 100B.30)

Work Function Authorization only applies to the active staff of the ‘BackOffice’ User

Type other than IT Staff. Work Function Authorization is the authorization into a particular Work Function of a Department. Work Function Authorization is used to limit other staffs from altering the records in the Work Functions that a group of staffs are responsible for. Numeric scores can be assigned to each task. At the end of each period, non-subjective reports from the tallying of the scores can be used to ascertain the efficiency of the Staffs. Since data of lateness in responses are kept at each record, Staff Responsiveness can also be measured. In the event of failure to or misjudgment on an action, responsibility can be properly assigned. The reverse is also true; credit can be given to the proper staff(s). Work Function Authorizations are set up in the staff file by his superiors.

### Copy or Transfer To Another Department (FIG. 100B.24)

This feature only available to the ‘BackOffice’ but excludes IT Staff, Pre-employment and Not Working For Firm. An InFoDoc Record and its Followup Records can be transferred, upon acceptance, to a Work Function area of another Department. A ‘Transfer’ would terminate the previous department from further handling and thus the responsibilities on the outcome of the records. A ‘Copy’ of these records, upon acceptance, can also be sent to another department. Handling and responsibilities to future outcomes of a ‘Copy’ would diverse after the copy was sent. ‘Copy or Transfer To Another Department’ is activated from the Reassignment of Responsibility button.

### Private Note (InFoDoc Record) (FIG. 100B.26)

Superiors can view the notes of the subordinates. From highest to lowest: Corporate Officer, Manager, Supervisor, Staff, and Salesperson. Client is not allowed to have Private Notes.

### Descriptions On User Types and Their Privileges

### User Types

User Types are ‘Clients,’ ‘Sales,’ ‘BackOffice,’ ‘Examiner,’ ‘Sales PreEmp’ and ‘Staff PreEmp.’ Each User Type has its correspondent Access Privileges, which are the authority to Insert, Change, Delete or View a record (User Type And Access Privileges, FIG. 100A.08).

### ‘Clients’ Access Privileges (FIG. 100A.10)

Basically, ‘Clients’ are referring to the Participants of accounts. He (He is referred to he or she) can view almost all records pertaining to any Client Accounts (accounts maintained in Firm), Vendor Accounts (third party accounts through Firm) and Participants of the accounts in which he is a part of. He is prevented from viewing certain areas where the BackOffice had set up account restrictions or limitations or areas where the profitability of the transactions is revealed. Client Account Participants can enter new transactions subject to Back Office approval.

### ‘Sales’ (FIG. 100A.12)

‘Sales’ refer to the salespersons who are selling products for the Firm, whether the salesperson is on W-2 or 1099 status. Access is restricted to the records of theirs' or their subordinates' clients.

### Sales User Access Class (FIG. 100A.20)

They are restricted to records of theirs and their subordinates, i.e. Branch Manager can view all his own, his Salespersons' and their Customers' records. ‘Sales’ is sub-divided into ‘Sales User Access Class’ of Salesperson, OSJ (Office Of Supervisory Jurisdiction) Branch Manager, Non-OSJ Manager and Not Selling For Firm.

‘Salesperson’ Access Privileges (FIG. 100A.26)
Salesperson can enter data into his own customer records but only BackOffice can do changes in the records

‘OSJ Manager’ Access Privileges (FIG. 100A.28)
Manager has the same privileges as all the Salespersons under his supervision. ‘OSJ Manager’ can also act as a ‘Supervisor’ for the ‘BackOffice.’

‘Non-OSJ Manager’ Access Privileges (FIG. 100A.30)
Manager has the same privileges as all the Salespersons under his supervision. ‘Non-OSJ Manager’ cannot act as a ‘Supervisor’ for the ‘BackOffice.’

‘Not Selling for Firm’ Access Privileges (FIG. 100A.32)
He no longer is employed as a salesperson. Therefore, he has no Access Privileges.

### ‘Pre-Employment’ (FIG. 100A.16)

‘Sales PreEmp’ and ‘Staff PreEmp’ are designations for the ‘Sales Pre-employment’ and ‘Staff Pre-employment.’

### ‘Sales Pre-Employment’ Access Privileges (FIG. 100A.22)

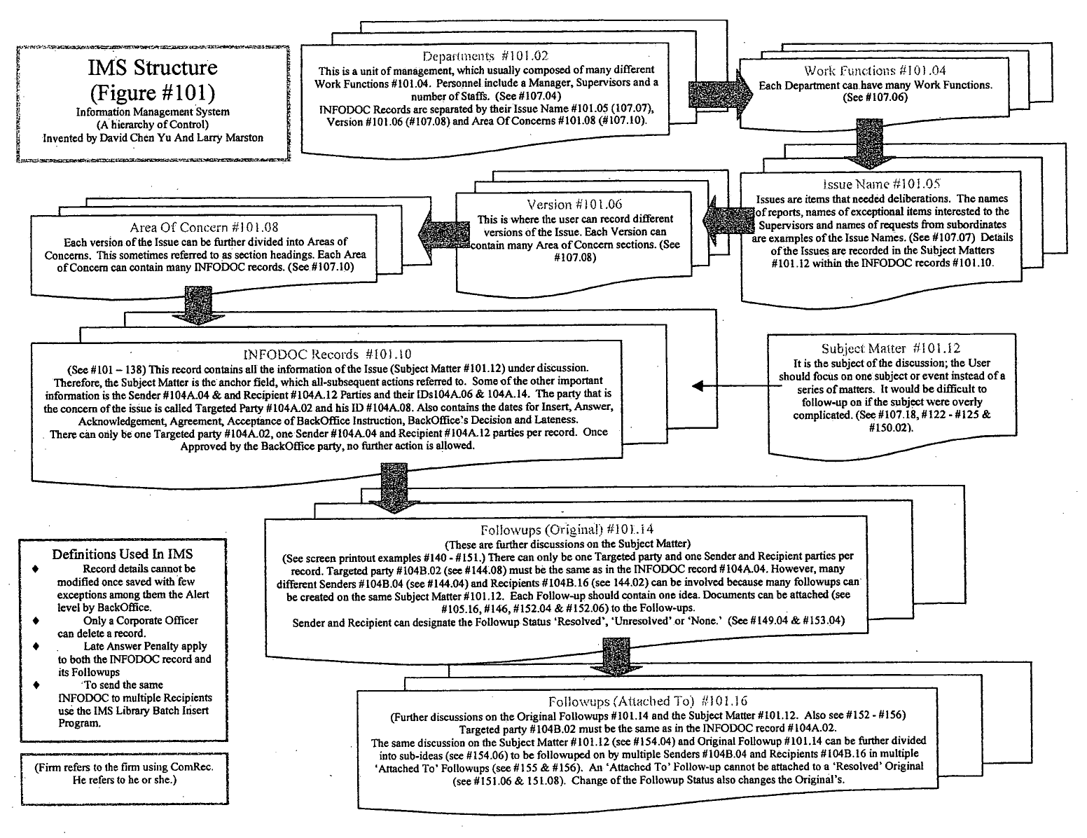

He can only access the Work Function (FIG. 101.04) areas of the Department of Sales Pre-employment when required by ‘BackOffice’. He can only respond to ‘BackOffice’ inquiries in the InFoDoc record, but he can initiate or respond to Followups.

### ‘Staff Pre-Employment’ Access Privileges (FIG. 100A.24)

He can only access the Work Function (FIG. 101.04) areas of the Department of Staff Pre-employment. He can only respond to ‘BackOffice’ inquiries in the InFoDoc record, but he can initiate or respond to Followups.

### ‘Examiner’ Access Privileges (FIG. 100A.18)

‘Examiner’ refers to any third party personnel who are given access privileges to ComRec by the Firm. They are usually outside auditors, regulatory examiners, advisors or investigators. They have broad access right to view all parts of ComRec and SMMS except where profit is displayed, but they have no right to change or insert any records.

### Backoffice (FIG. 100B.02, From 100A.14)

‘BackOffice’ refers to all person working in the back office of the firm. They are allowed to access all areas of the ComRec and SMMS system whether or not records exist but are limited by their ‘Back Office User Access Class,’ ‘Access Privileges’ and ‘Work Function Authorization’ (discussed earlier in Definitions).

### Backoffice User Access Class and Access Privileges (FIG. 100B.04)

BackOffice is sub-divided into ‘BackOffice User Access Class’ of: Staff, Supervisor, Manager, Corporate Officer, IT Staff and Not Working For Firm. Only a ‘Superior’ can appoint the same level and subordinates and assigns their Access Authorizations. All BackOffice staffs can view all Sales and Customer records except the User IDs and Passwords fields.

### Corporate Officer Access Privileges (FIG. 100B.06)

In almost all circumstances, only Corporate Officers can delete records. Only he can view and set up any data relating to net profit and net margin of the business. Only he can appoint another Corporate Officer.

Corporate Officer Work Function Authorization (FIG. 100B.18)
Corporate Officer is automatically given the Work Function authority to access all parts of ComRec and SMMS.

### Manager Access Privileges (FIG. 100B.08)

Manager sets Firm policies in the Firm file, and enter other relevant data in all other files relating to the Firm-wide level. ‘Work Function Authorization’ (discussed earlier in Definitions).

### Supervisor Access Privileges (FIG. 100B.10)

Supervisor does all the approvals and primary monitoring of all activities. He is also primarily responsible for assigning Work Function Authorization to staffs. ‘Work Function Authorization’ (discussed earlier in Definitions).

### Staff Access Privileges (FIG. 100B.12)

Staff (BackOffice) does all the data entries and maintenance of the files. ‘Work Function Authorization’ (discussed earlier in Definitions).

### IT Staff Access Privileges (FIG. 100B.14)

IT Staff can view all areas of ComRec and SMMS except areas restricted to Corporate Officer only. No insert or change is allowed.

IT Staff Work Function Authorization (FIG. 100B.22)
He can only view but has authorization to access to all Work Functions areas of all Departments.

### Not Working for Firm Access Privileges (FIG. 100B.16)

No Access Privileges and Work Function Authorizations.

### SMMS Structure (FIG. 101)

Subject Matter Management System (SMMS) manages information collected from multiple sources and methods in a highly structured manner as described in Summary of the Invention. Some of the features of SMMS are:

### Color Coded for Priority and Current User Party (FIG. 105A.26)

Red is the color for the highest priority; black, the regular color for fonts is the next priority; gray and silver are of the lowest priorities. Occasionally, blue is used instead of black; to make the item stand out more.

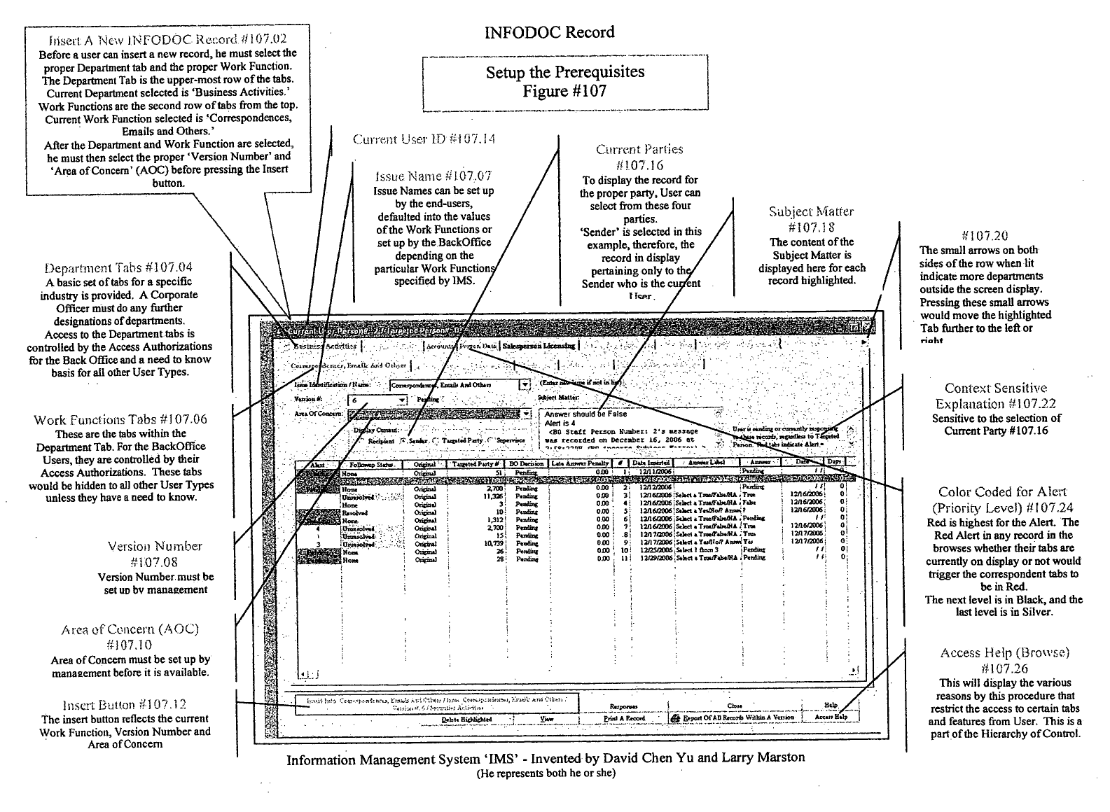

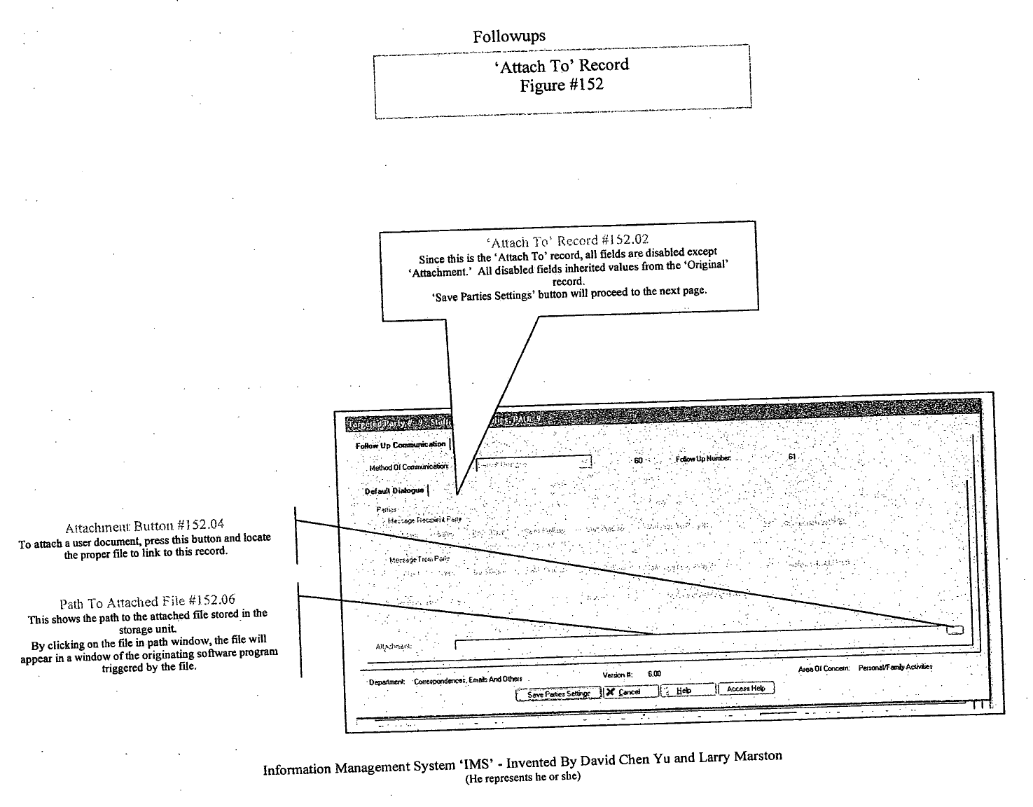

In the Department Browse, the colors of the tabs (See FIG. 107.04, 107.06, 128.04) reflect the highest Alert priority of all records in the browse whether they are in current view or not for the selected Current User Party. (FIG. 107.16, 128.08) In the Followup browse, the color (FIG. 151.06, 156.02) indicates whether the records are ‘Original’ or ‘Attached To’ and whether the record is ‘Resolved’, ‘Unresolved’ or ‘None.’

### Preset Messages (FIG. 105A.18)

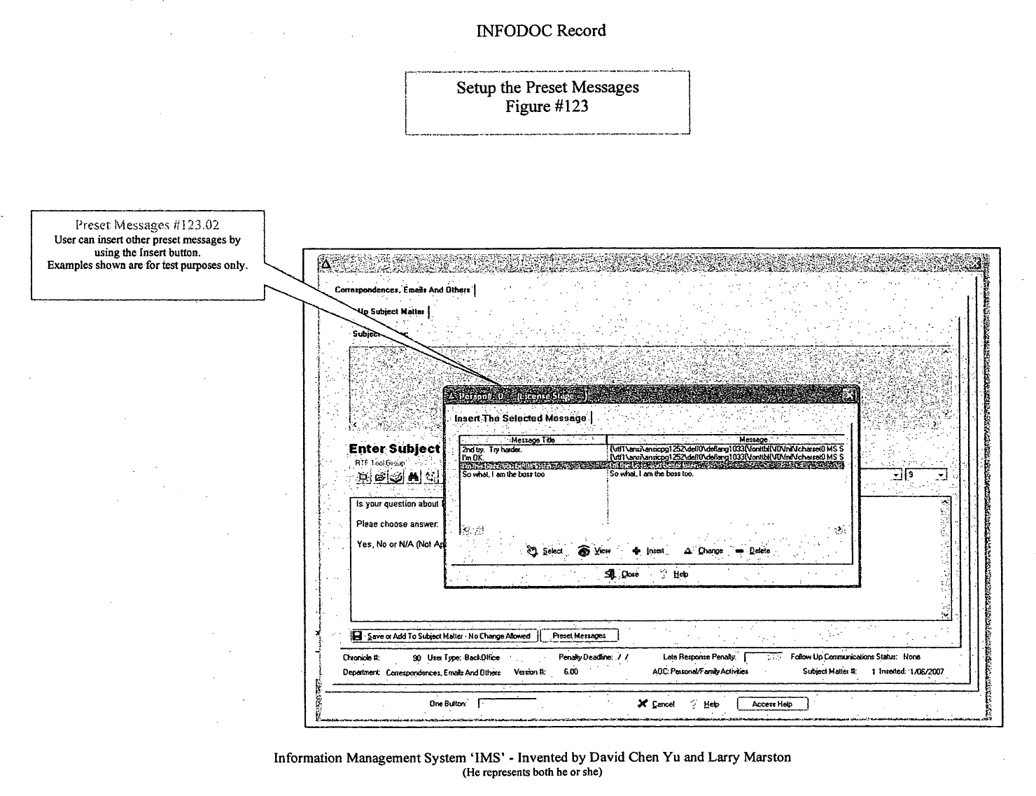

(See FIG. 123) Preset Messages are available for Manuel Entry into InFoDoc records, entry into SMMS Library Programs and Followup records. These are messages set up by end users that they would be using repeatedly.

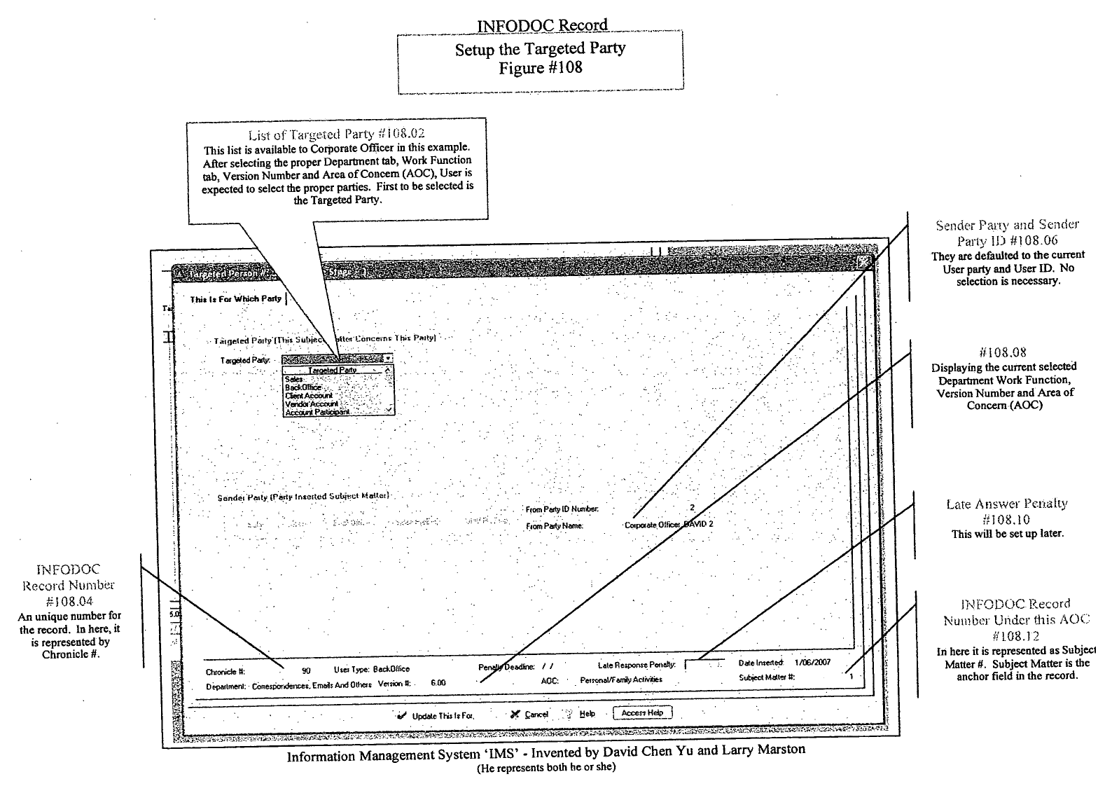

Late Answer Penalty (FIG. 105A.20, see also FIG. 108.10, 111, 141.08)

Late Answer Penalty applies to Manual Entry, SMMS Library Programs, Form Programs, Supervisory Messages, Licensing, CE and Periodic Procedures. (FIG. 102A-102C.) System Messages (FIG. 102A.22) would not generate any Late Answer Penalty since no response is expected. Supervisory staff can eliminate the Penalty after its imposition. Late Answer Penalty can be imposed on InFoDoc entries (FIGS. 102A & 102B). In Followups (FIG. 102C), it would be defaulted to the same amount and to be activated after the same number of days as in the InFoDoc record (FIG. 101.10) where it was originated.

Only a Sender (FIG. 104A.02) from the BackOffice (FIG. 100B.02) can set up the Late Answer Penalty.

### Attachments (FIG. 105A.22)

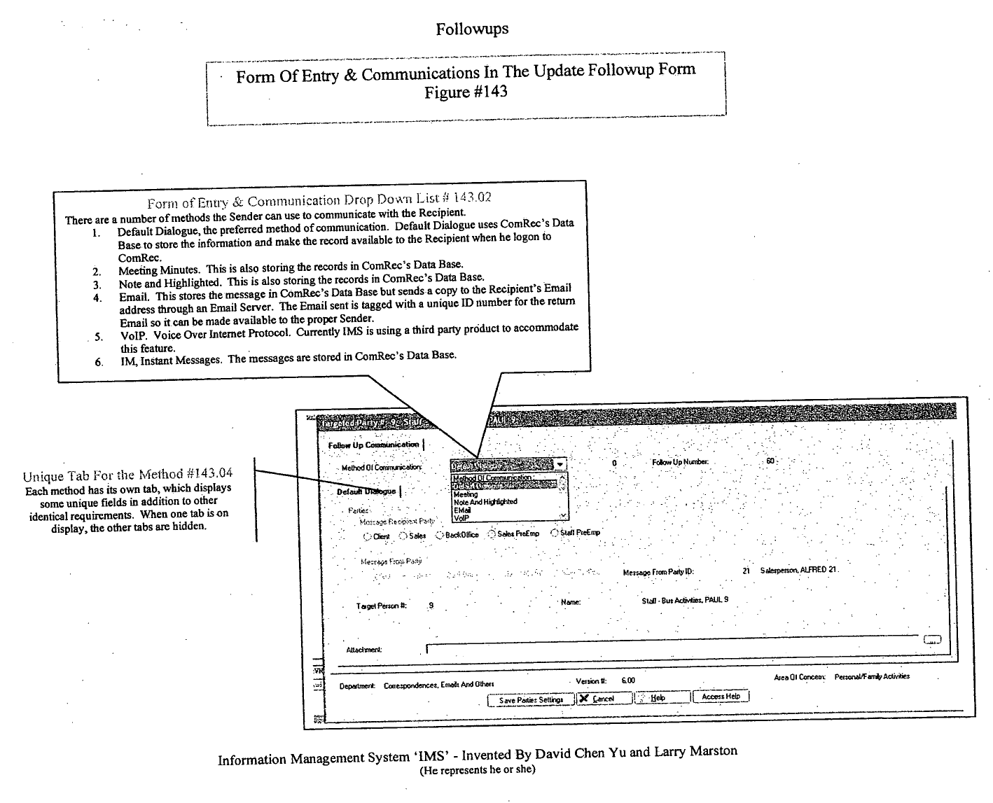

(See FIG. 142.10, 146, 151.08, 152.04, and 152.06) Attachments are files such as scanned documents, text documents, PDF or BLOB files belonging to users. Their locations in the storage unit can be identified, relocated to proper storage location and linked to the relevant InFoDoc record (FIG. 101.10) or Followup record (FIG. 101.14 & 101.16). These attachments can be retrieved, printed, transferred and copied to another department (FIG. 101.02) and e-mailed to a Recipient (FIG. 104A.08 & 104B.12). By attaching to the proper record, the attachments can be viewed in the same context as the rest of the discussions related to the same Subject Matter (FIG. 101.12) in InFoDoc (FIG. 101.10).

### ‘InFoDoc’ RECORD (FIG. 101.10):

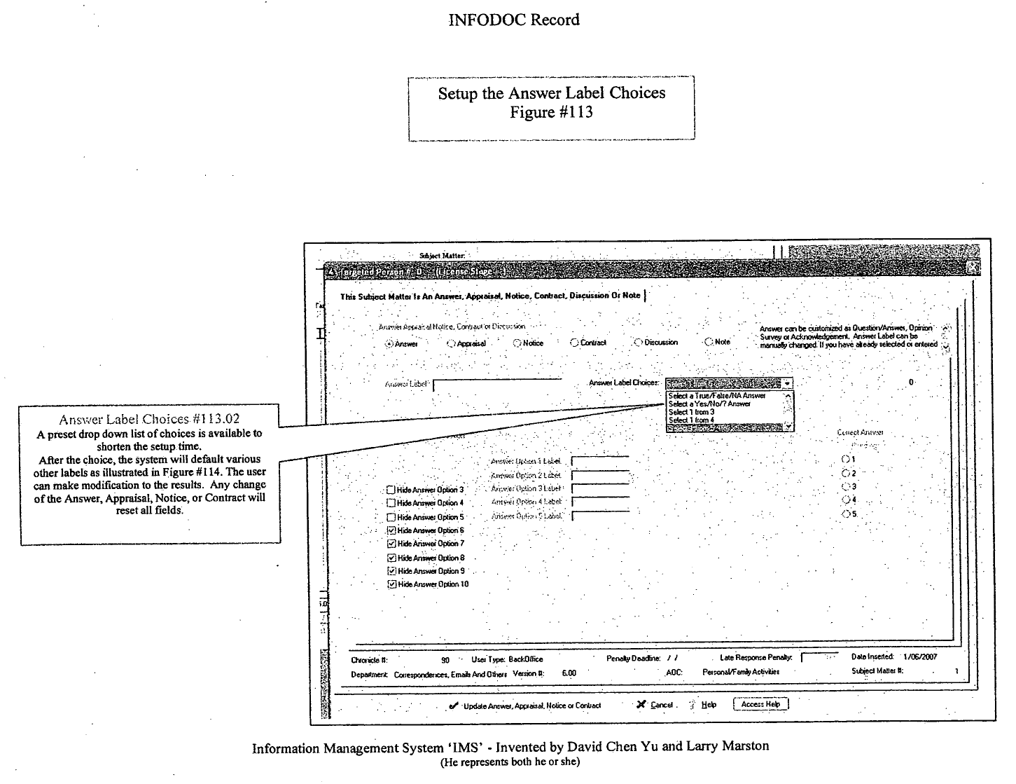

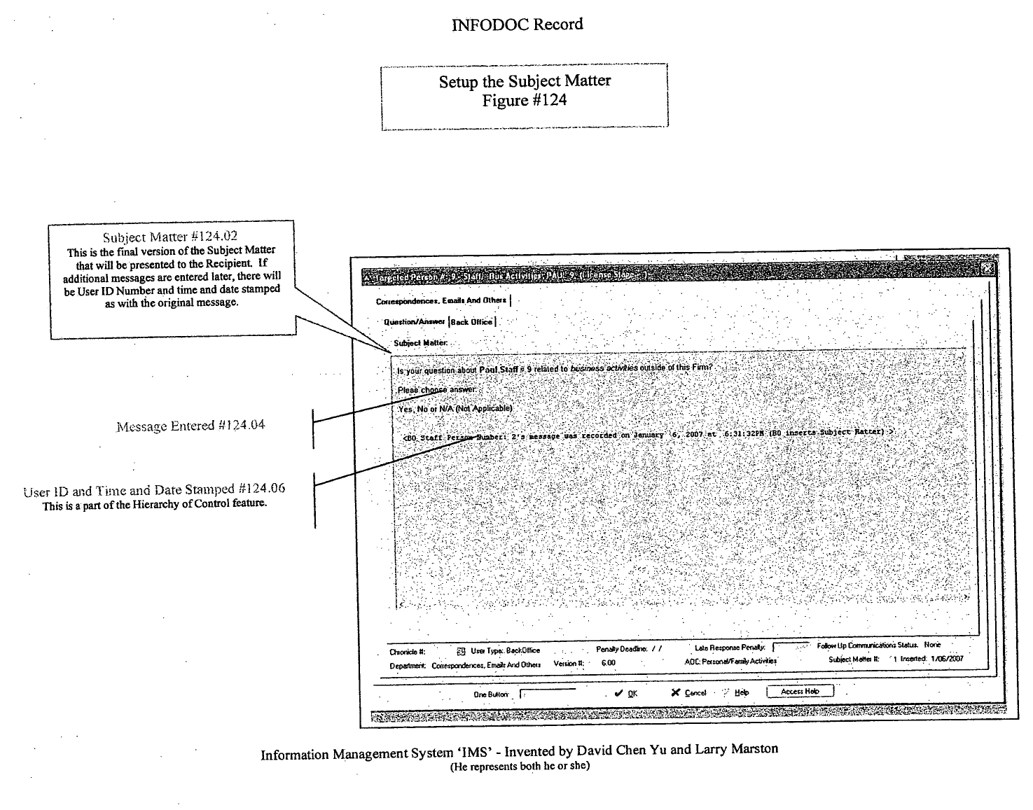

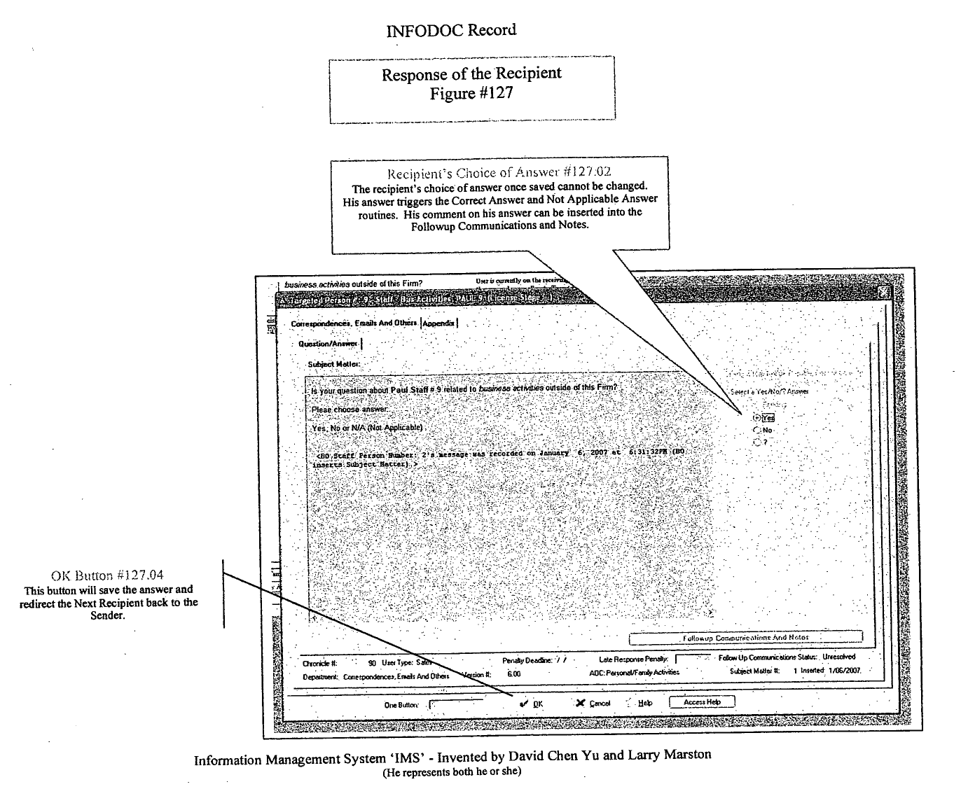

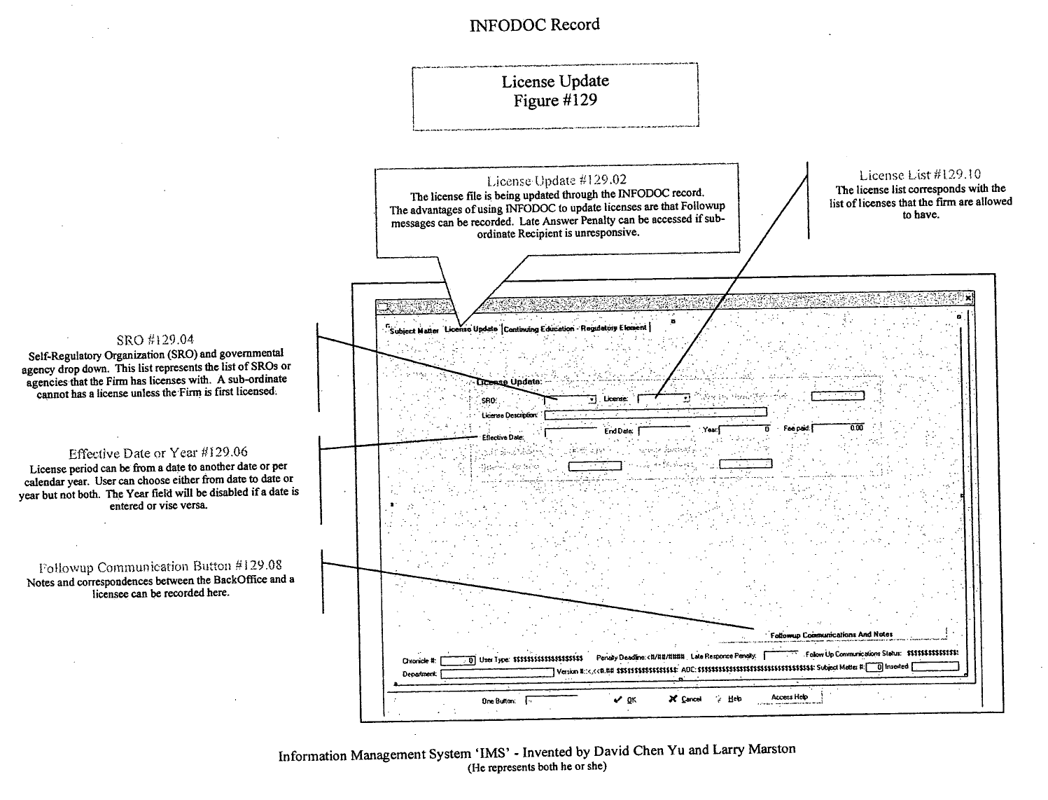

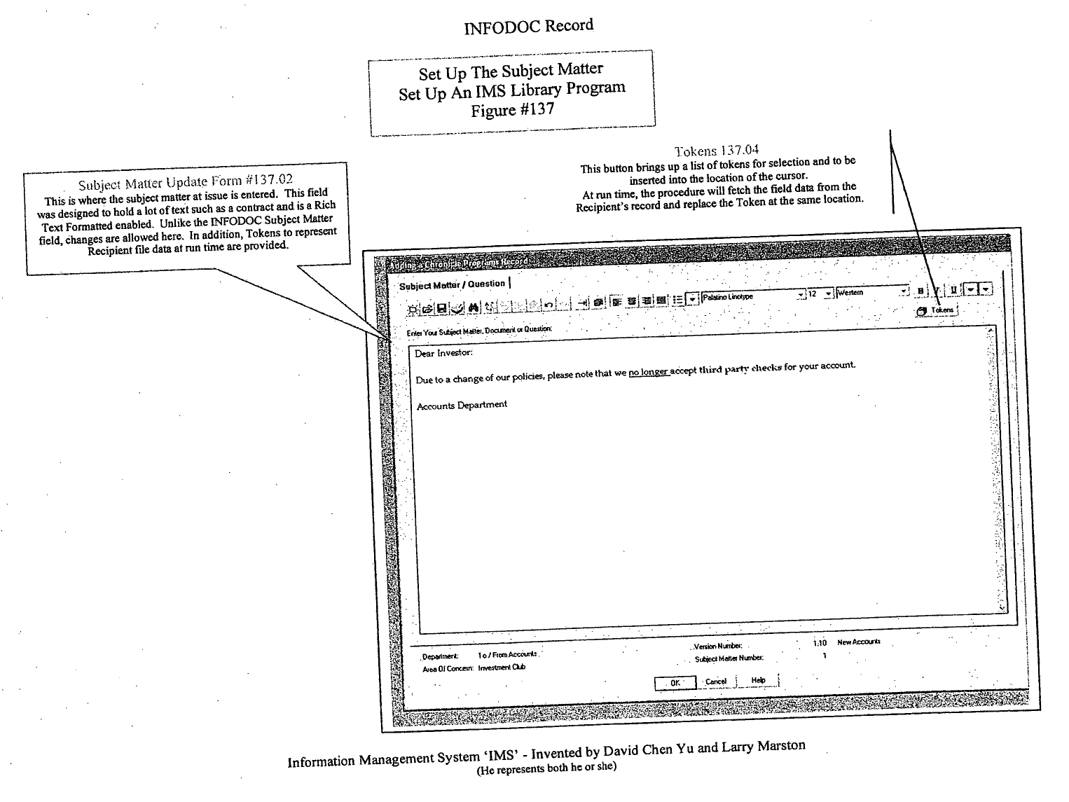

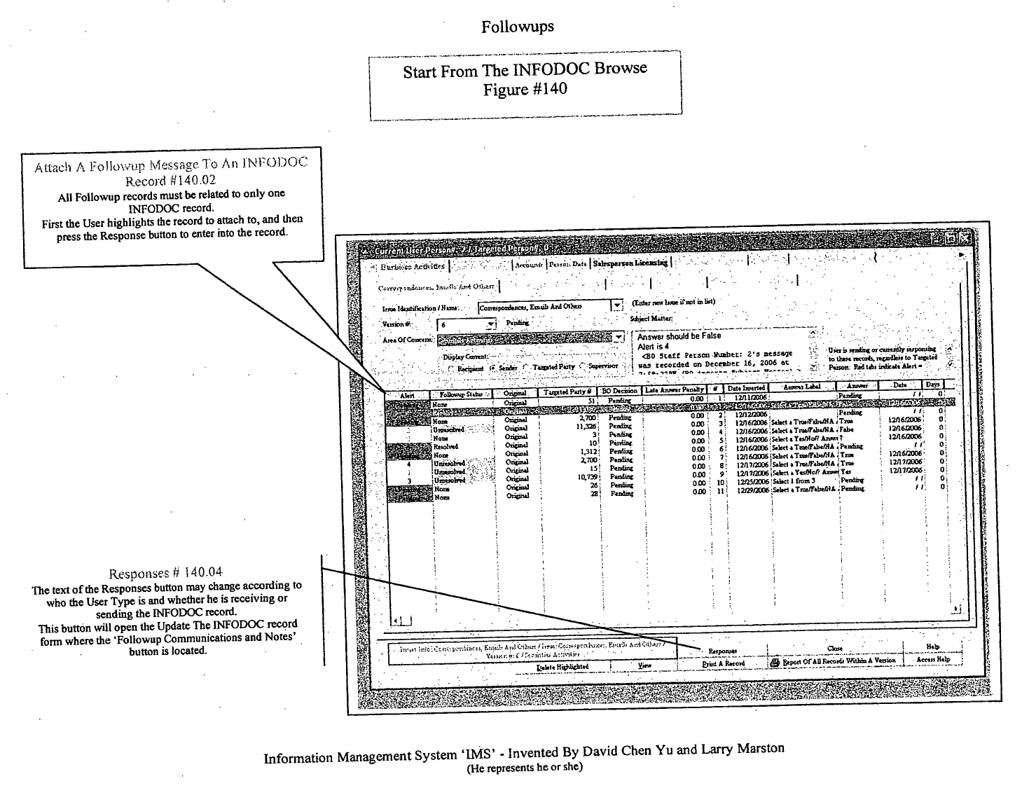

(See FIG. 103A.10, FIG. 101-138) This record contains all the information supporting the Subject Matter (FIG. 101.12) under discussion.

### ‘Subject Matter’ (FIG. 101.12)

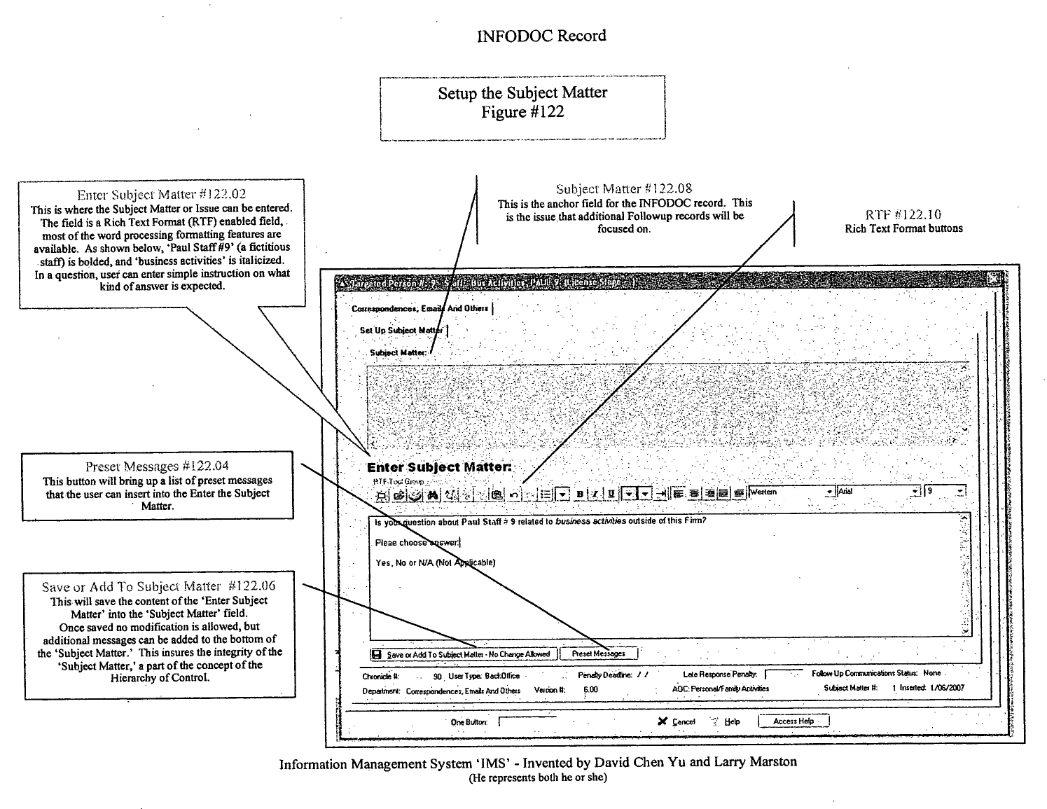

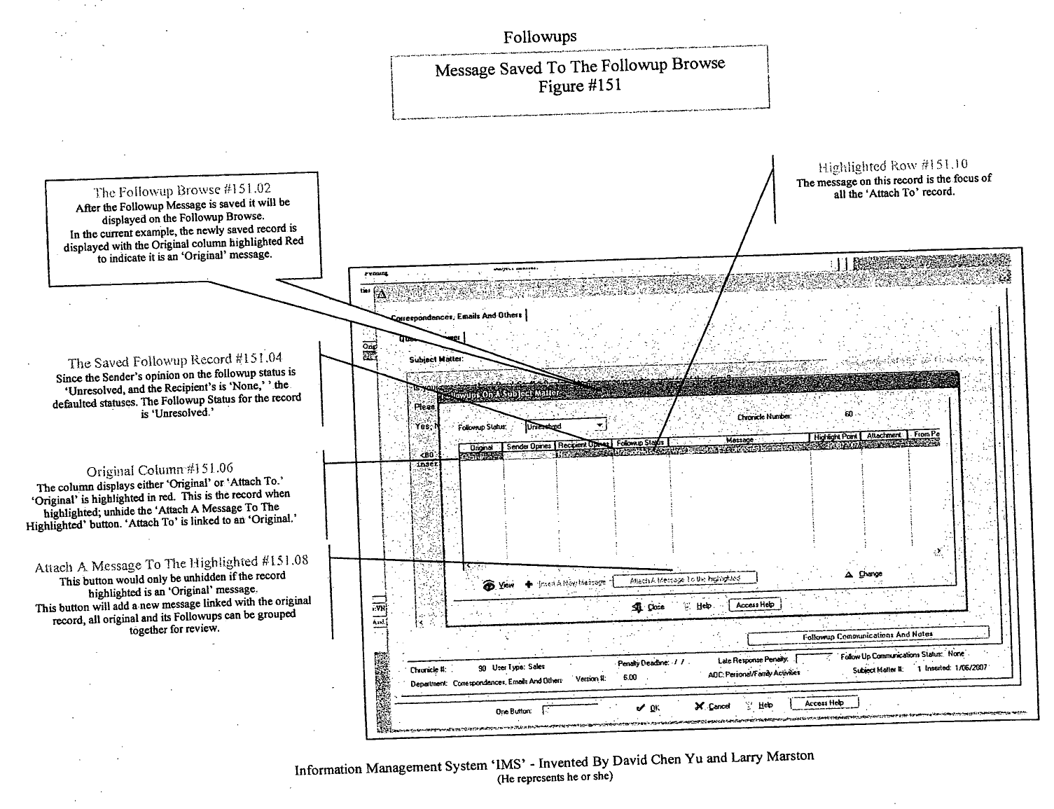

It is the subject of the discussion; the User should focus on one subject or event instead of a series of matters. It would be difficult to follow-up on if the subject were overly complicated. (See FIG. 107.18, FIG. 122-FIG. 125 & FIG. 150.02). The Subject Matter is the anchor field, which all-subsequent actions referred to. The Subject Matter (FIG. 101.12, FIG. 100.16, FIG. 107.18, FIG. 122-FIG. 125) is a Rich Text Formatted (RTF) field which can accommodate a large legal document and can be formatted to resemble a letterhead.

### Alert and Back Office (BO) Decision (FIG. 105A.02)

(See FIGS. 107.24, 125.06, and 132.04) Only Back Office can modify the Alert Level.

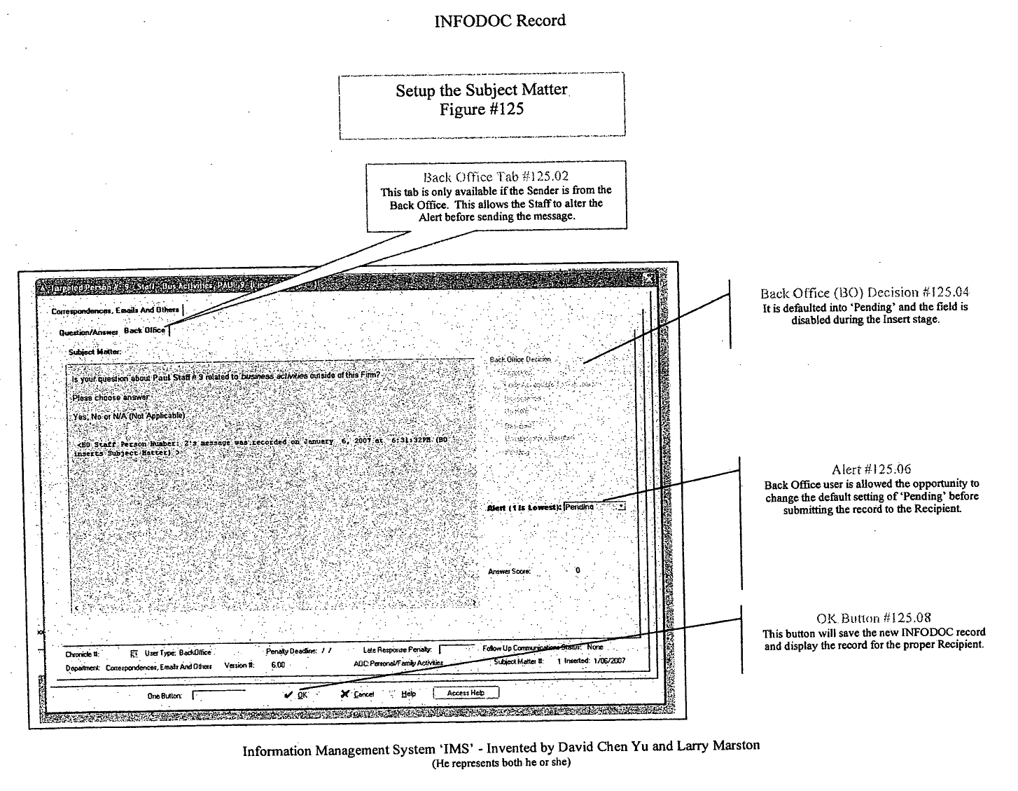

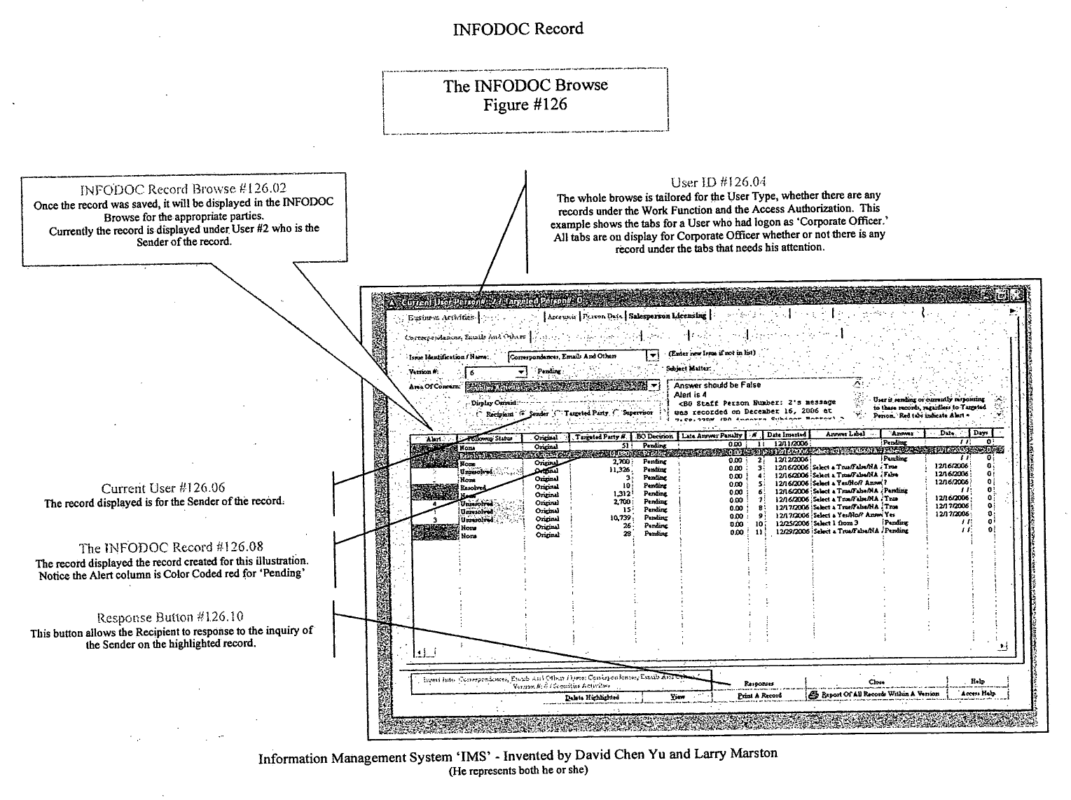

Alert levels are ‘Approved,’ ‘1,’ ‘Disapproved,’ ‘2,’ ‘3,’ ‘4’ and ‘Pending.’ Unless modified by the system, 1 equates ‘BackOffice Decision’ of ‘Verify Acceptable To Subordinate.’ This is the default value after the Subordinate accepted BO Instructions, Disapproved equates ‘Disapproved,’ 2 ‘On Hold,’ 3 ‘Resubmit,’ 4 ‘Unsatisfactory, Resubmit,’ Pending as ‘Pending’ and Approved would be ‘Approved’ in BO Decision. Alert level (FIG. 125.06) modified by BackOffice Users (FIG. 100B.02 will override the default value triggered by the BO Decision (FIG. 125.04) selection.

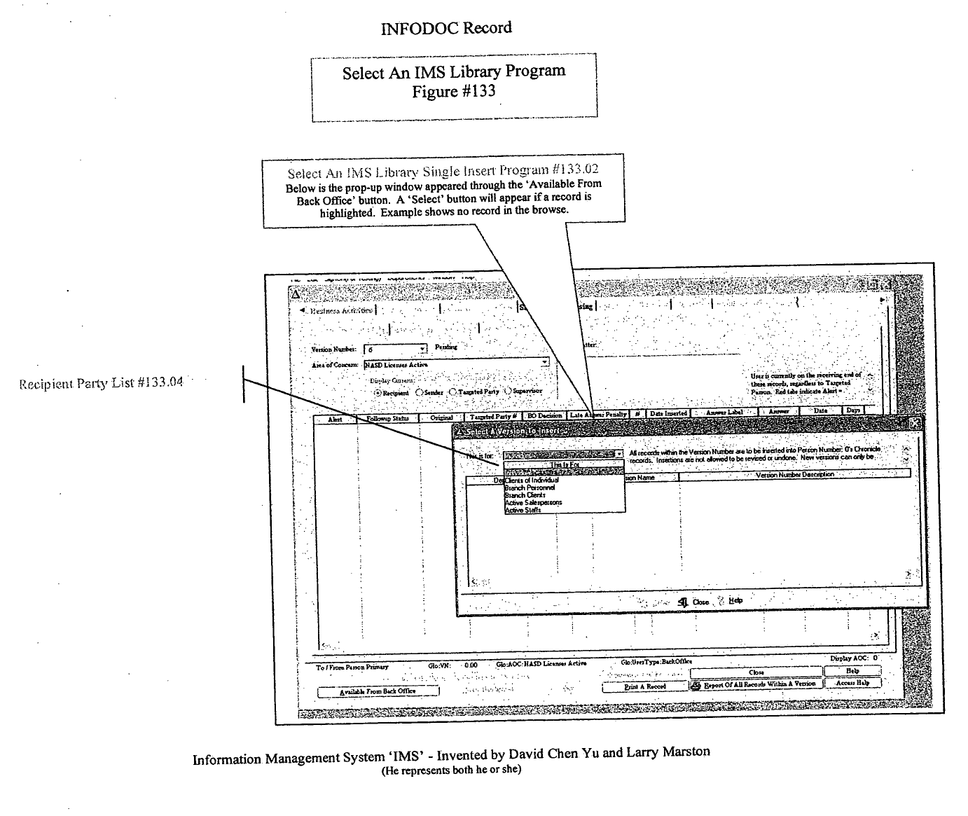

Alert is the first column (FIG. 132.04) in the Department Browse to indicate its importance. Column can be sorted ascending or descending by clicking at the column heading.

With the diligent updating of the Alert level, staffs (FIG. 100B.02) can monitor a much larger amount of outstanding issues at any one time. ‘BO Appraisal of Subordinate’ will not be available until the decision is ‘Approved’ or ‘Disapproved.’

Once Approved by the BackOffice party, no further action is allowed.

### Back Office Instruction is Acceptable (FIG. 105A.06)

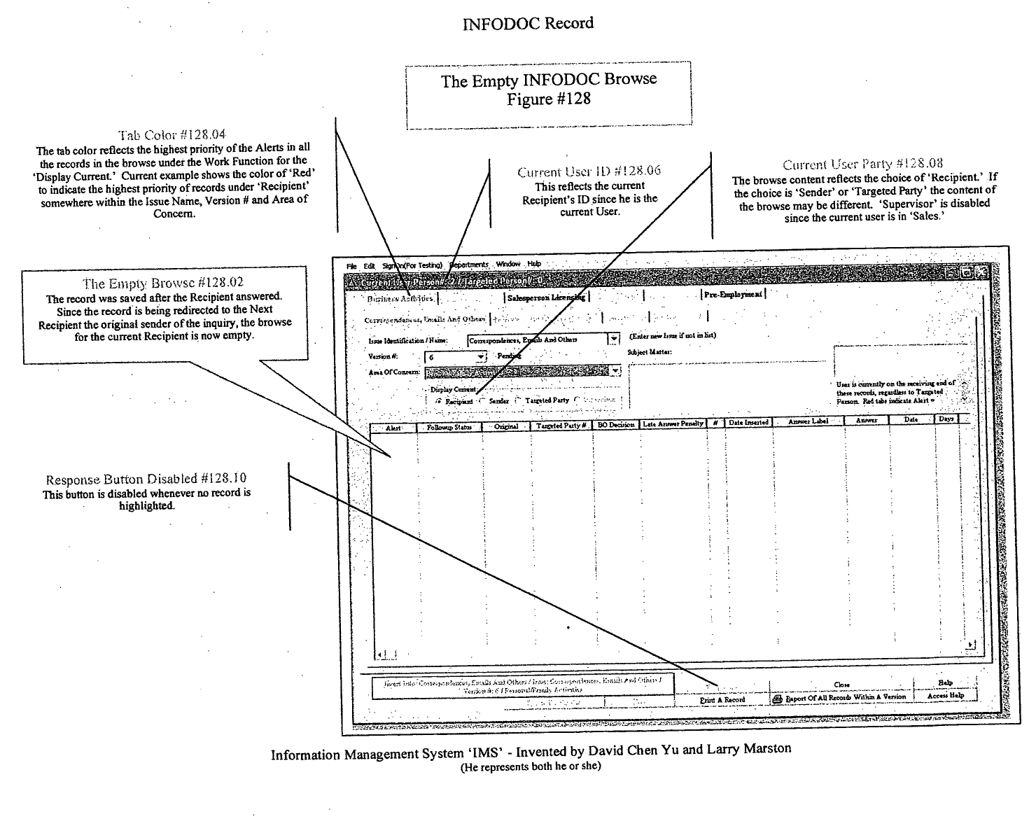

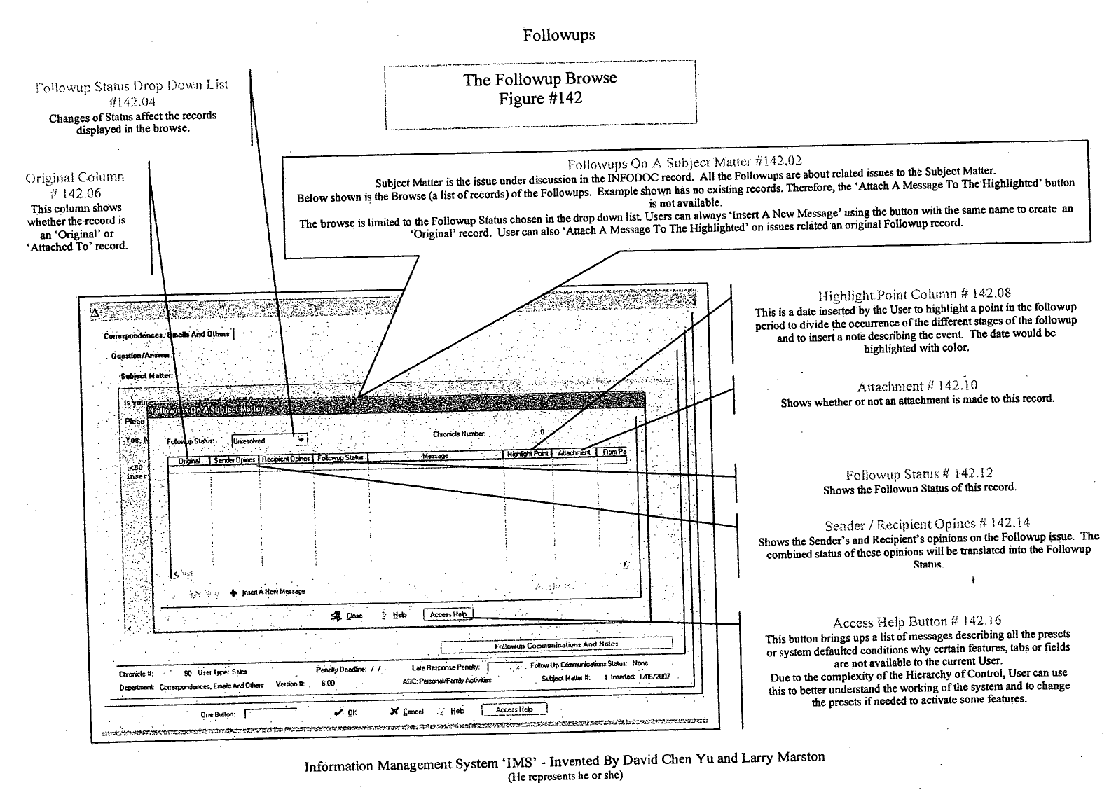

After selection of an answer (FIG. 127.02) and after all Followup issues are ‘Resolved,’ (FIG. 141.10, 149.04, 153.04) a subordinate is presented the ‘True’ and ‘False’ choice of ‘Back Office Instruction Is Acceptable.’ This choice would not be required if there are no Followups, therefore, no BO instructions. ‘Appraisal Of BO Service’ only available after Answer or ‘BO Instruction Is Acceptable.’

### Appraisal of Sender and Recipient (FIG. 105A.04)

Sender (FIG. 104A.02) and Recipient (FIG. 104A.08) whose relationship is Superior (FIG. 100B.28) and subordinate are expected to appraise each other of the experience at the conclusion of the discussion (Subject Matter FIG. 101.12) in the InFoDoc record (FIG. 101.10 and FIG. 105A.04).

### ‘Followups’ (Original) (FIG. 101.14-FIG. 101.16)

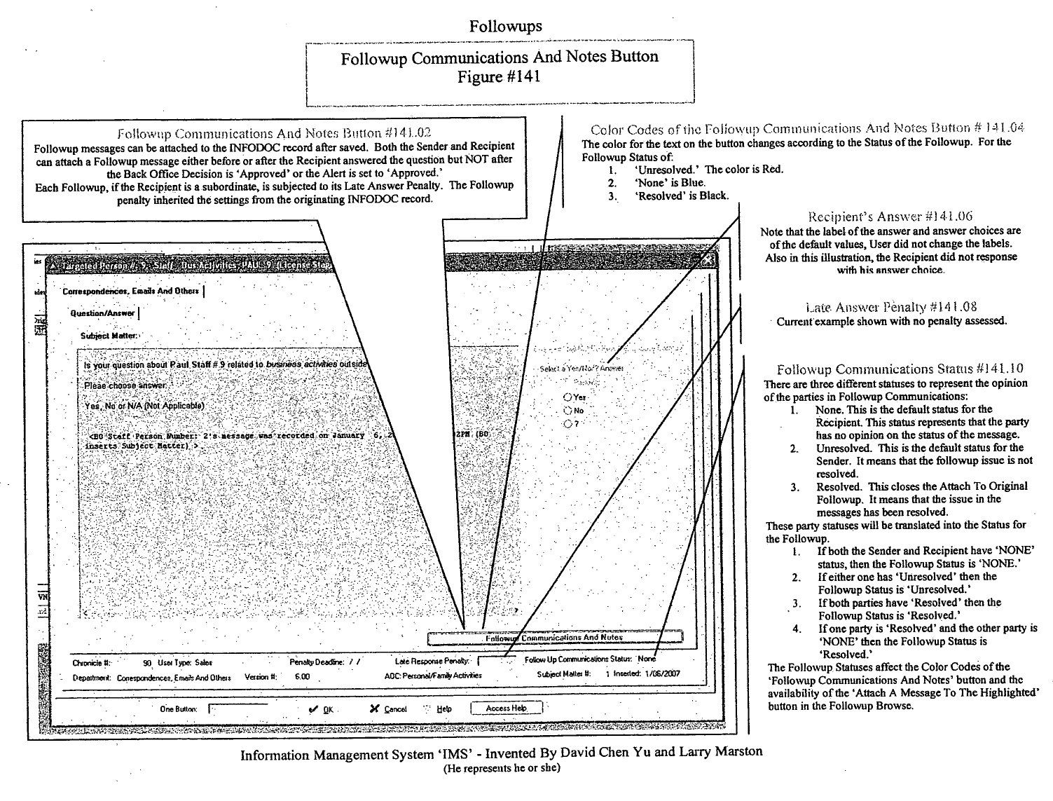

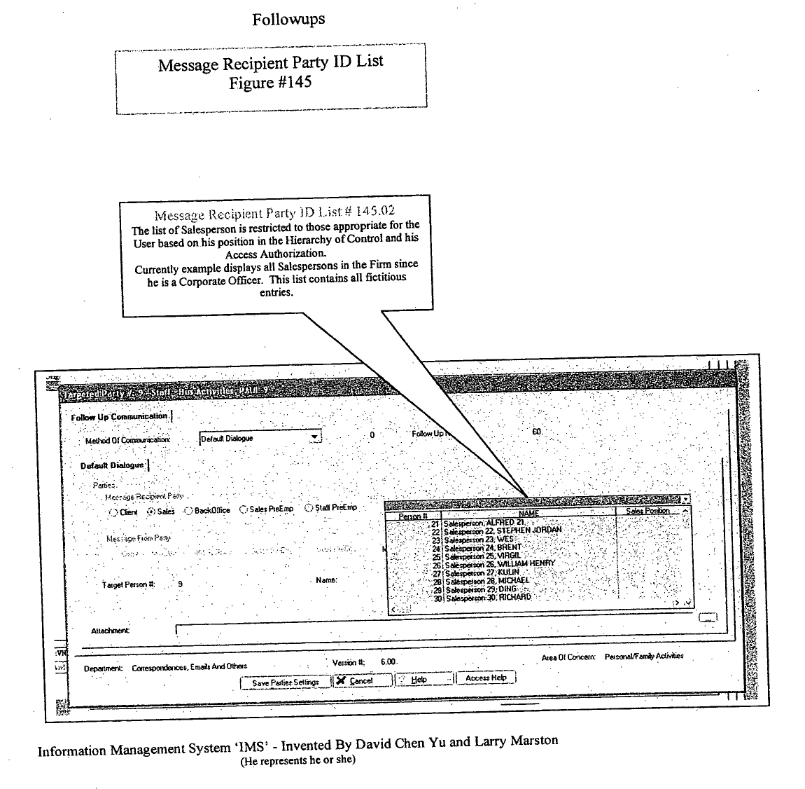

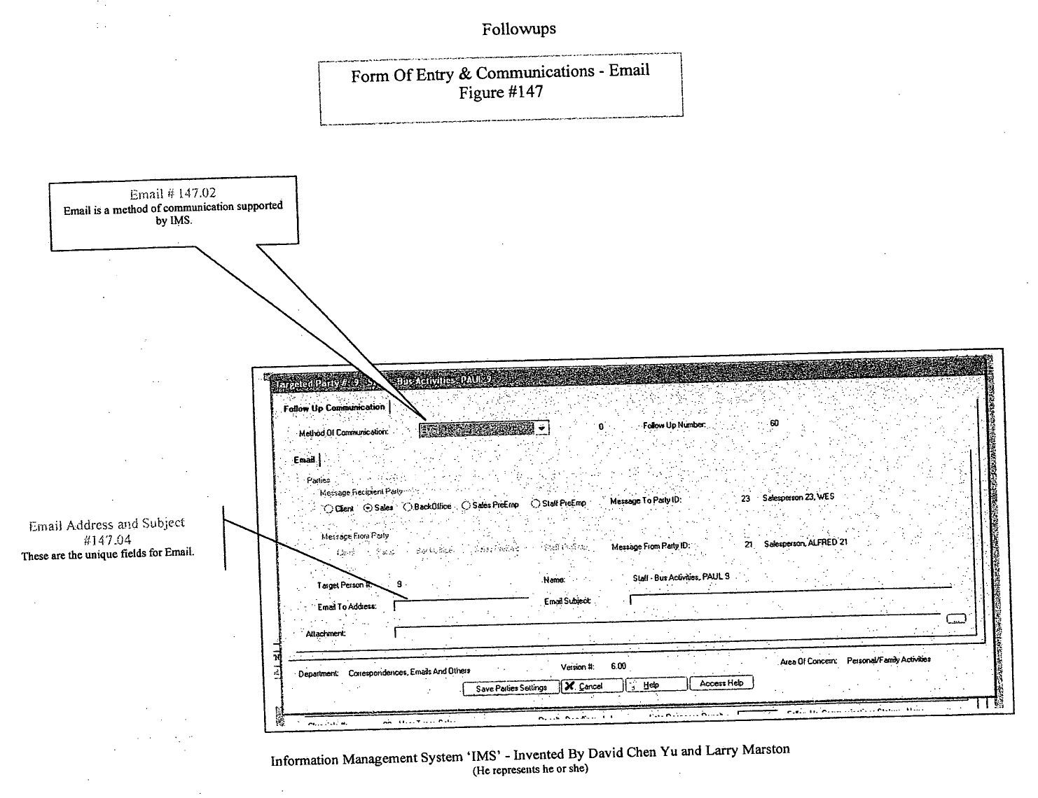

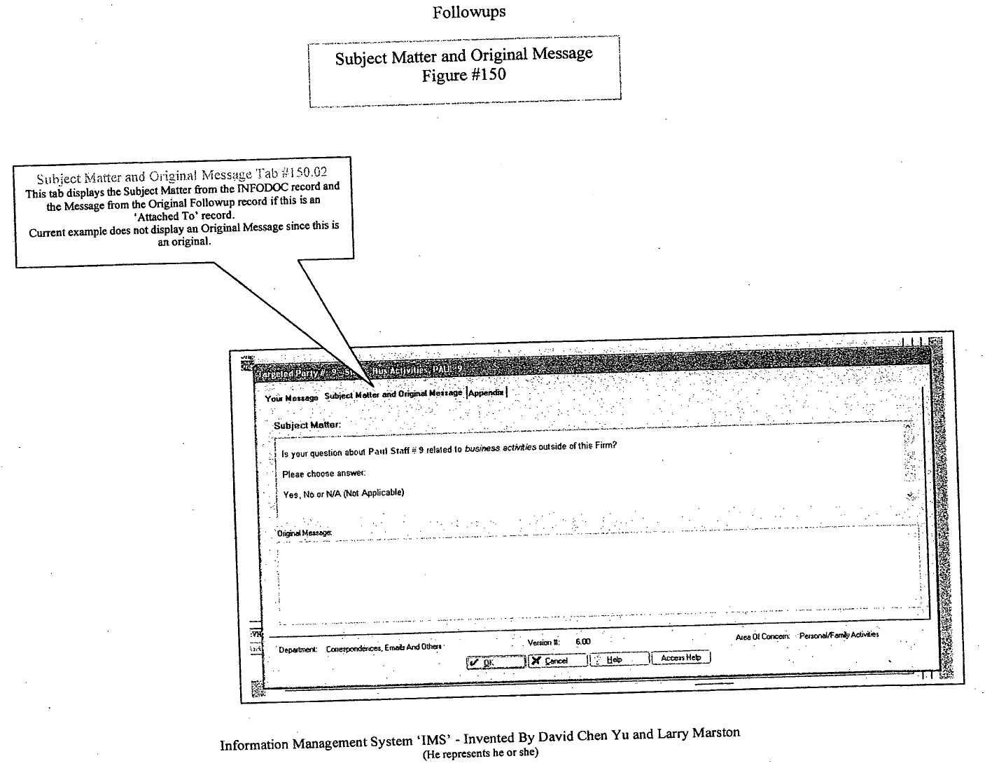

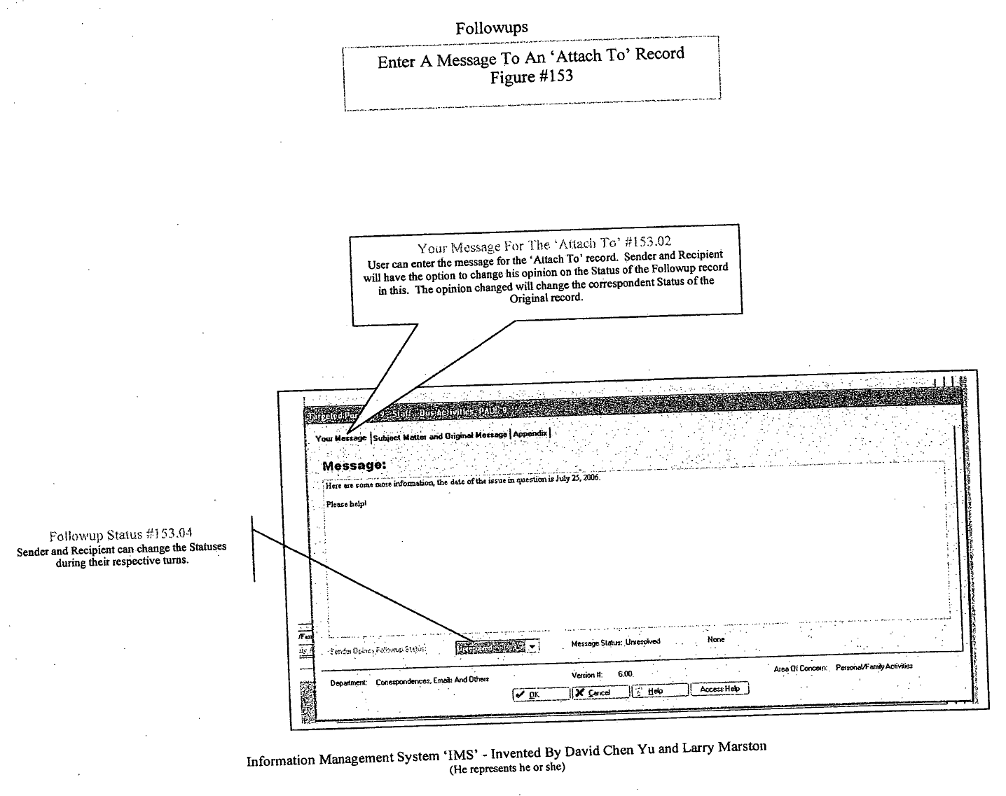

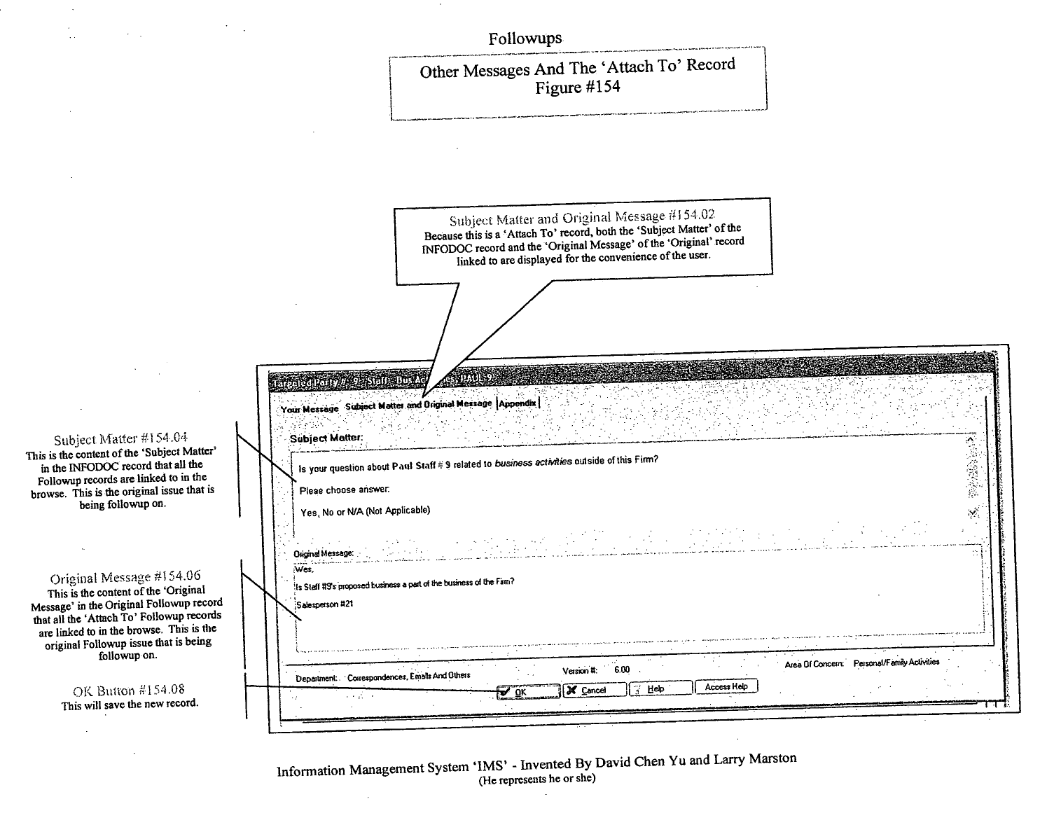

These are further discussions on the Subject Matter (See screen printout examples FIG. 140-FIG. 151.) It can be inserted from the InFoDoc record (FIG. 101.10, FIG. 141.02). There can only be one Targeted party and one Sender and Recipient parties per record. Targeted party (FIG. 104B.02, see also FIG. 144.08) must be the same as in the InFoDoc record (FIG. 104A.04). However, because many followups can be created on the same Subject Matter (FIG. 101.12) many different Senders (FIG. 104B.04, see also FIG. 144.04) and Recipients (FIG. 104B.16, see also 144.02) can be involved. Each Follow-up should contain one new idea. Documents can be attached (see FIG. 105.16, FIG. 146, FIG. 152.04 & FIG. 152.06) to the Follow-ups. Sender and Recipient can designate the Followup Status ‘Resolved’, ‘Unresolved’ or ‘None.’ (See FIG. 149.04 & FIG. 153.04)

### Attached to ‘Followups’ (FIG. 101.16)

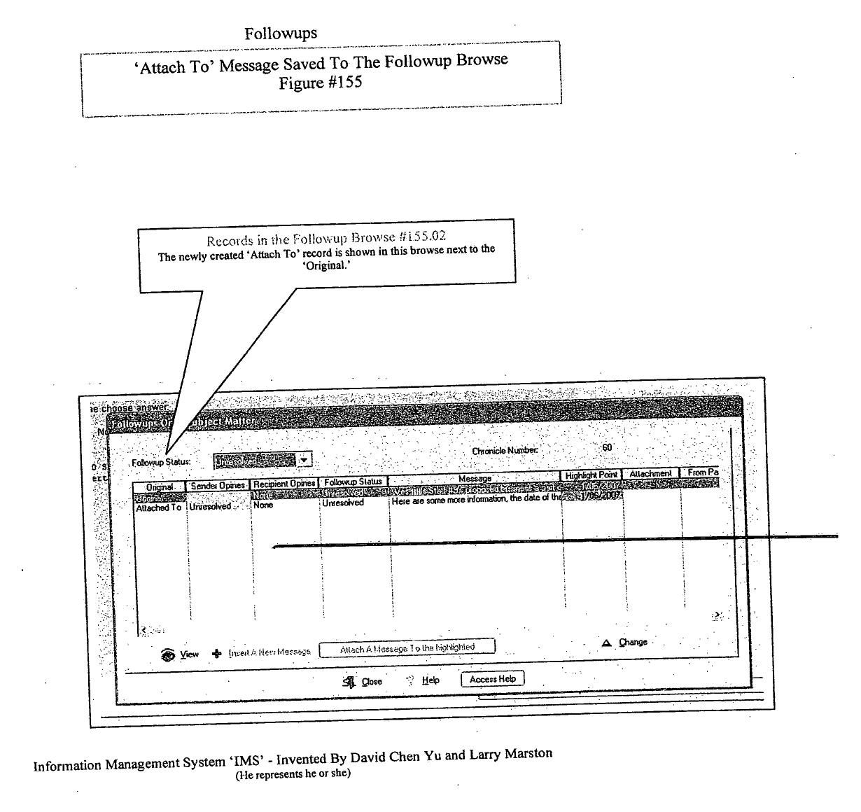

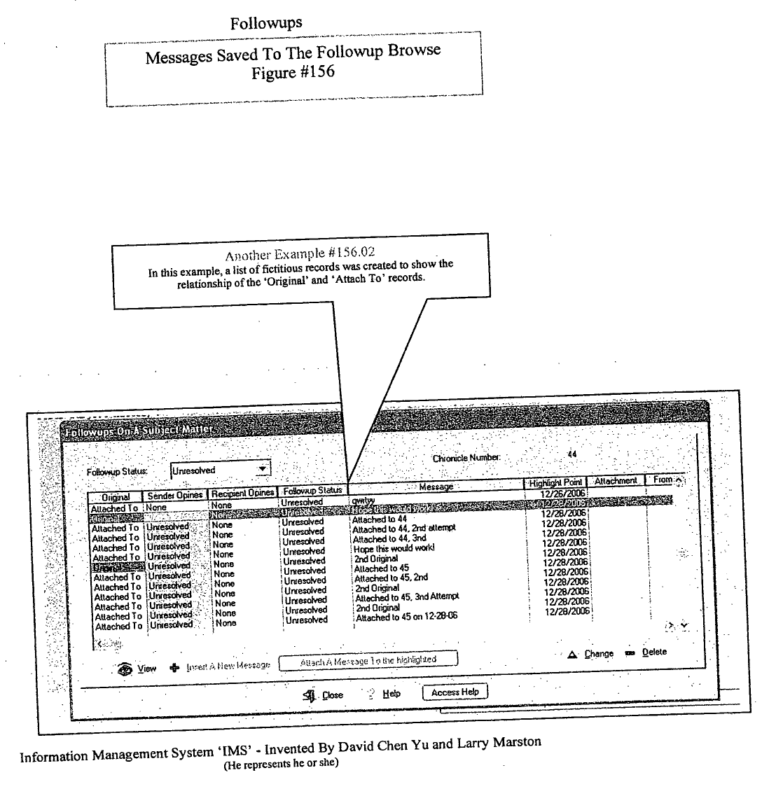

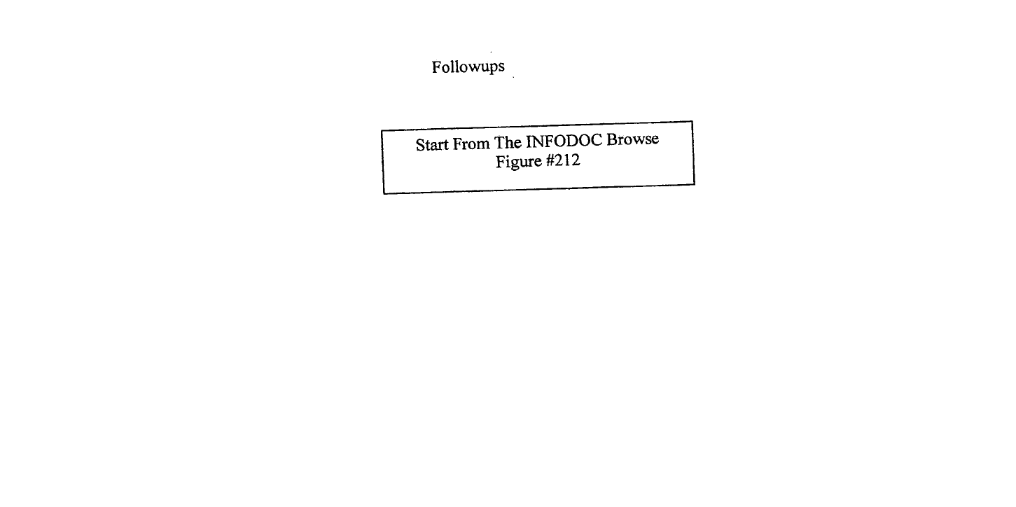

Further discussions on the original ‘Followups’ (FIG. 101.14) and the ‘Subject Matter’ (FIG. 101.12) can be entered into a Followup record and attached that record to a previous Followup record that the further discussion originated (Also see FIG. 152-FIG. 156). Targeted party (FIG. 104B.02) must be the same as in the InFoDoc record (FIG. 104A.02). An ‘Attached To’ Follow-up cannot be attached to a ‘Resolved’ Original (see FIG. 151.06 & 151.08). Change of the Followup Status also changes the Original's.

### Highlight Insertion Point (FIG. 105B.08)

(See FIG. 142.08, 151.06 & 151.10) This is a part of the Followup Note (FIG. 103B.08) function that allows the user to enter a Highlight Date, which this record can be sorted on. Notes can be entered and the record will be highlighted in the Browse. This is used to separate the events by time periods. This is useful in followup discussion that lasts over a long period of time.

### Primary Sorting Order

To minimize the learning curve, the primary presentation of SMMS mimics common corporate structure; SMMS arranges the InFoDoc records according to the Department that the record belongs, then the Work Function within the Department, then the Issue at question, such as assigned duty of a staff, a project, a customer account inquiry, etc . . . then the Version Number and the Area of Concern within the Version.

‘Departments’ (FIG. 101.02): This is a unit of management, which usually composed of many different Work Functions (FIG. 101.04). Personnel include a Manager, Supervisors and a number of Staffs (See FIG. 107.04).

‘Work Functions’ (FIG. 101.04): Each Department can have many Work Functions. (See FIG. 107.06)

‘Issue Name’ (FIG. 101.05): Issues are items that needed deliberations. The names of reports, names of exceptional items interested to the Supervisors and names of requests from subordinates are examples of the Issue Names. (See FIG. 107.07) Details of the Issues are recorded in the Subject Matters (FIG. 101.12) within the InFoDoc records (FIG. 101.10).

‘Version’ (FIG. 101.06, see also FIG. 107.08): This is where the user can record different versions of the Issue. Each Version can contain many Area of Concern sections.

‘Area Of Concern’ (FIG. 101.08, see also FIG. 107.10): Each version of the Issue can be further divided into Areas of Concerns. This sometimes referred to as section headings. Each Area of Concern can contain many InFoDoc records.

### InFoDoc Propagate Programs (FIG. 102A, FIG. 102B and FIG. 102C)

InFoDoc records can be inserted in a variety of ways. Manual Entry is the primary means of entry. SMMS Library Programs automate many routines customized (‘preset’) by Managers of Firm. Form Library Program creates and inserts preset Form and Contract requirements based on the preset needs of the newly appointed Salespersons or Clients. Continuing Education (‘CE’) and Licensing Programs inserts preset CE and Licensing requirements and Superior approval and Alert requirements into InFoDoc for followup and also insert records into the Jurisdiction Files (‘SRO’) for the Salespersons and Supervisors, these requirements are based on preset Frequencies (FIG. 105A.12). Supervisory Messages are generated by SMMS for the benefit of performing responsibilities of the Superiors. System Messages are also generated by SMMS to record alterations; insertions and deletions of various non-InFoDoc records, System Messages for InFoDoc records are recorded in their followups.

### Manual Entry

Manual Entry Into InFoDoc Record (FIG. 102A.02, see also FIG. 107-FIG. 128): Enter one record at a time into InFoDoc record by a Sender (FIG. 104A.02). Sender must choose a Targeted Party (FIG. 104A.02, 108.02) and the Targeted Party ID (FIG. 104A.08, 109.02). He must also select the Recipient Party (FIG. 104A.12, 110.04) and the Recipient Party ID (FIG. 104A.14, 110.02). He must choose the Form of Entry & Communication (FIG. 103A, 112.04), Question/Answer (FIG. 103A.02, 112-116), Opinion Survey/Appraisal (FIG. 103A.04, 117), Notice/Acknowledgement (FIG. 103A.06, 118), Contract/Agreement (FIG. 103A.08, 119), Discussion/Meeting Minutes (FIG. 103A.14, 120), Private Note (103A.16, 121), etc . . .

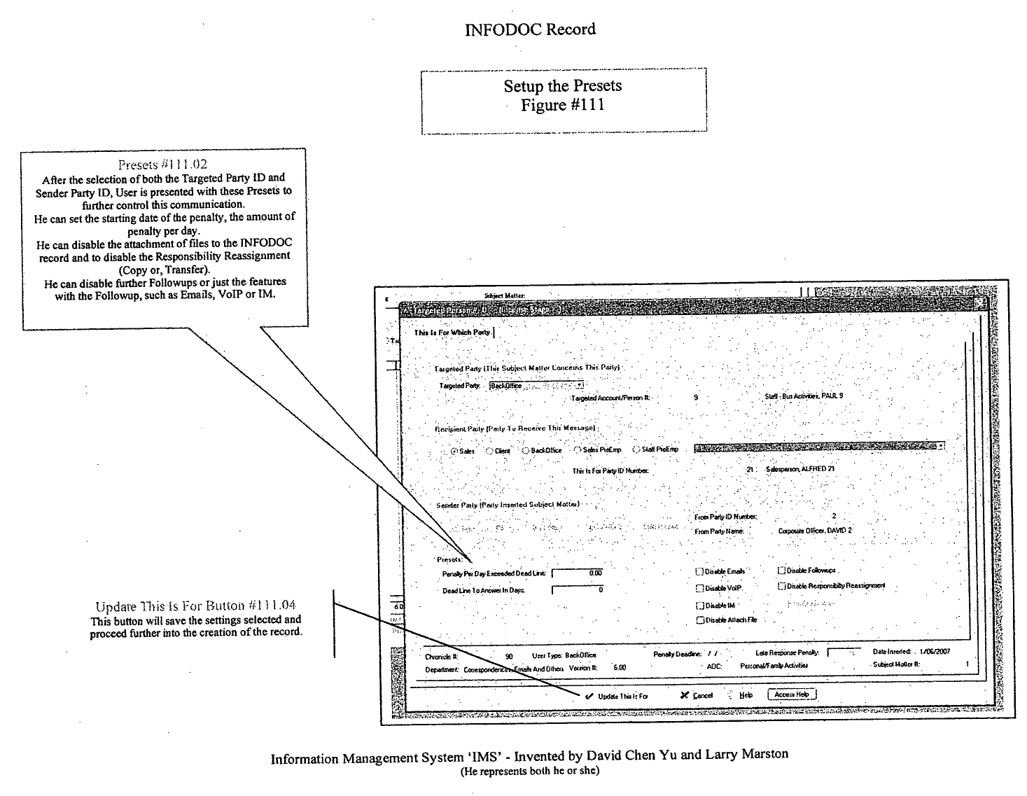

If the Sender (FIG. 104A.04) is from the BackOffice, he must set the Late Answer Penalty (FIG. 105A.20, 108.10, 111, 141.08), and whether to disable any Followups, or just the individual Followup Presets (FIG. 111.02). By the use of Preset Messages (FIG. 105A.18, FIG. 122.04, 123), Manual entry can be speeded up.

### SMMS Library Programs

SMMS Library program comprises of SMMS Library Single Insert Program (FIG. 102A.04), SMMS Library Batch Insert Program (FIG. 102A.06) and Periodic Procedures Program (FIG. 102A.08).

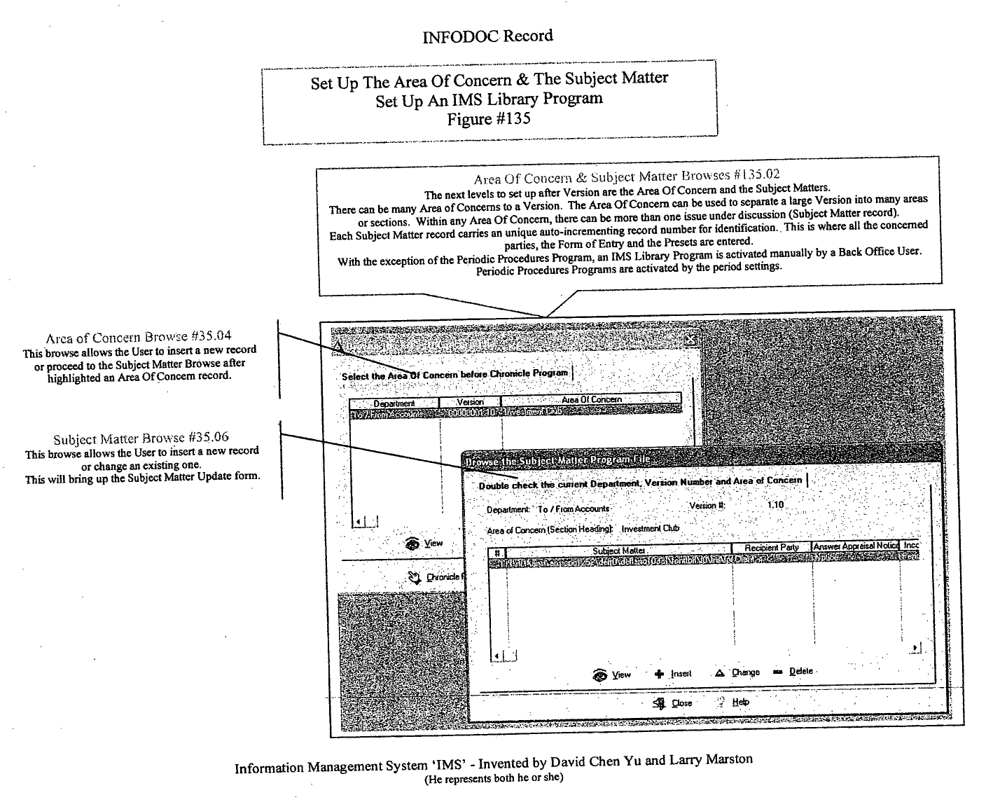

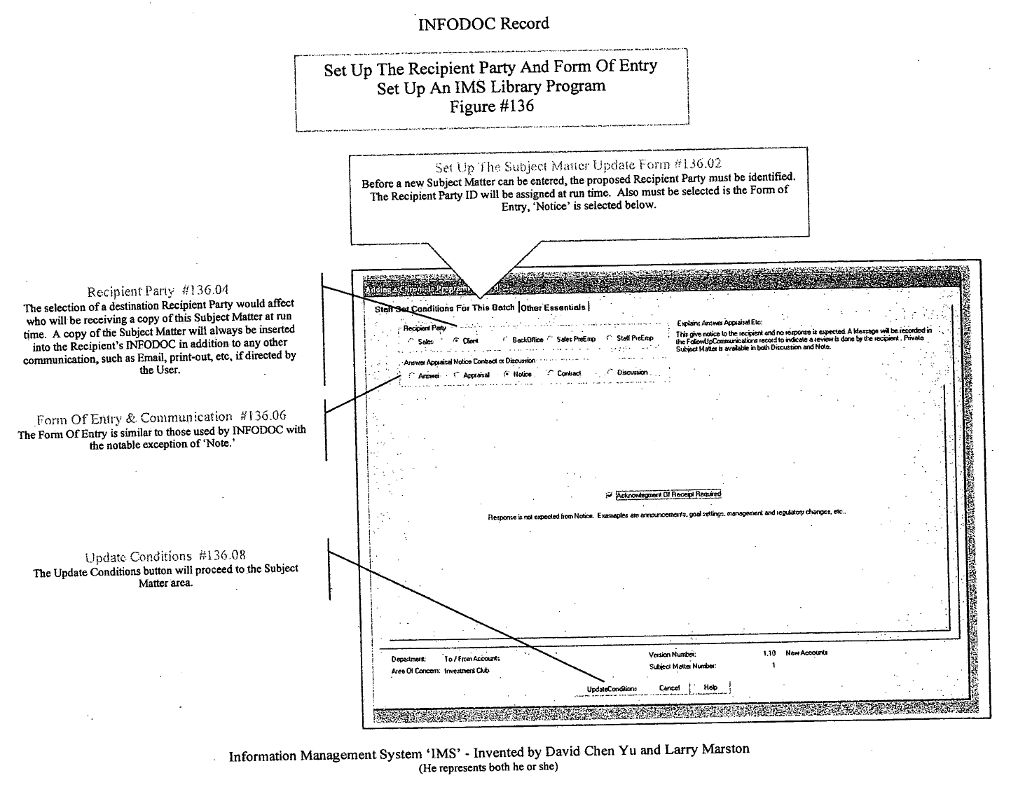

SMMS Library Program (FIG. 134-137) is a series of records the end user has set up before hand in SMMS Library Program File. In each Program, the user enters the Subject Matter and other required fields in the records of the Library (FIG. 135-137).

SMMS Library Single Insert Program (FIG. 102B.06, see also FIG. 132.06, 133-137)

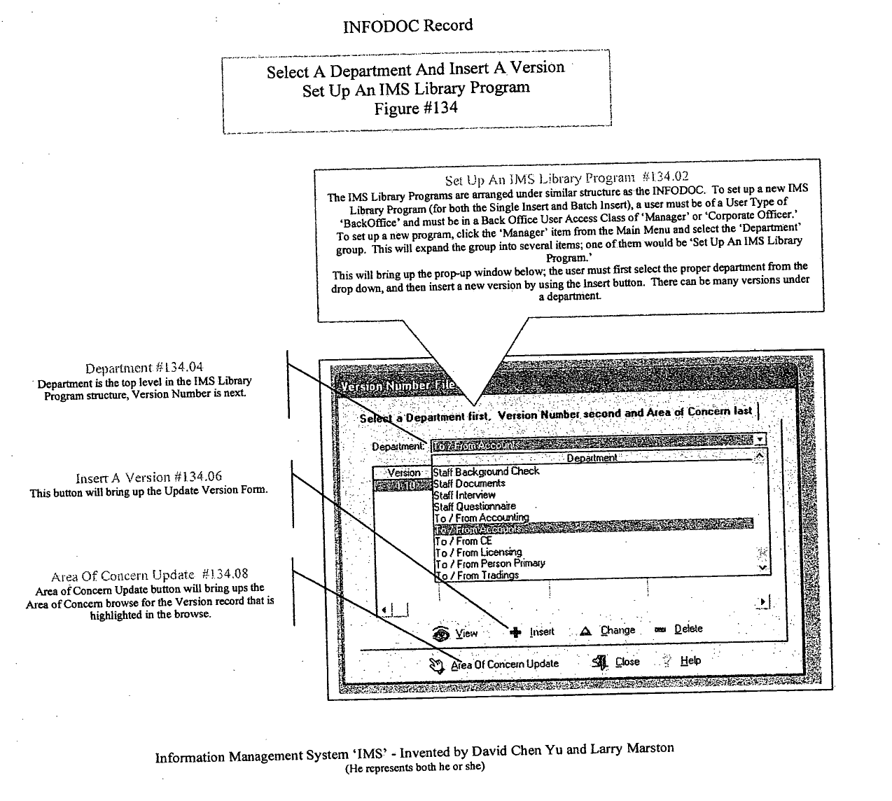

This program enables the entry of a record (One to One) into InFoDoc (FIG. 101.10) by selecting any one of the pre-defined records in the SMMS Library Program (FIG. 133). Target party is defaulted into the same Targeted party as in the InFoDoc record that was highlighted (FIG. 132.08) in the department browse. Selection is done through the ‘Available From BackOffice’ Button (FIG. 132.06) in the Department Browse screen.

SMMS Library Batch Insert Program (FIG. 102B.08, see also FIG. 133-137)

By selecting any one of the pre-defined SMMS Library Programs, this program enables the entry of multiple InFoDoc records (One to Many) into SMMS (FIG. 101.10). Selection is done through the ‘Batch Insert Programs’ selection under the Manager menu item. This selection calls the same browse as in the Single Insert Program (FIG. 133.02), however, instead of inserting one record, the system detected where the selection was done and will insert a series of InFoDoc records into SMMS for the type of predefined Recipients. By the use of Filters (FIG. 102B.16), the user can narrow the insert into only those Recipients that he intended. Target party is defaulted into the Recipient party unless the user selects another party.

Filters (FIG. 102B.16)
Filters are the operations whereby the use of logical expressions such as: equal, greater or less then, true or false, are use to qualify field values at run time. At run time means during an operation that is triggered by the User pressing a button or some other events.
The field values are the data from the Recipient's personal or account records. In here, Filters are used to narrow the list of Recipients for the One to Many operations in both the SMMS Library Batch Insert Program (FIG. 102B.08) and Periodic Procedures Program (FIG. 102B.12).

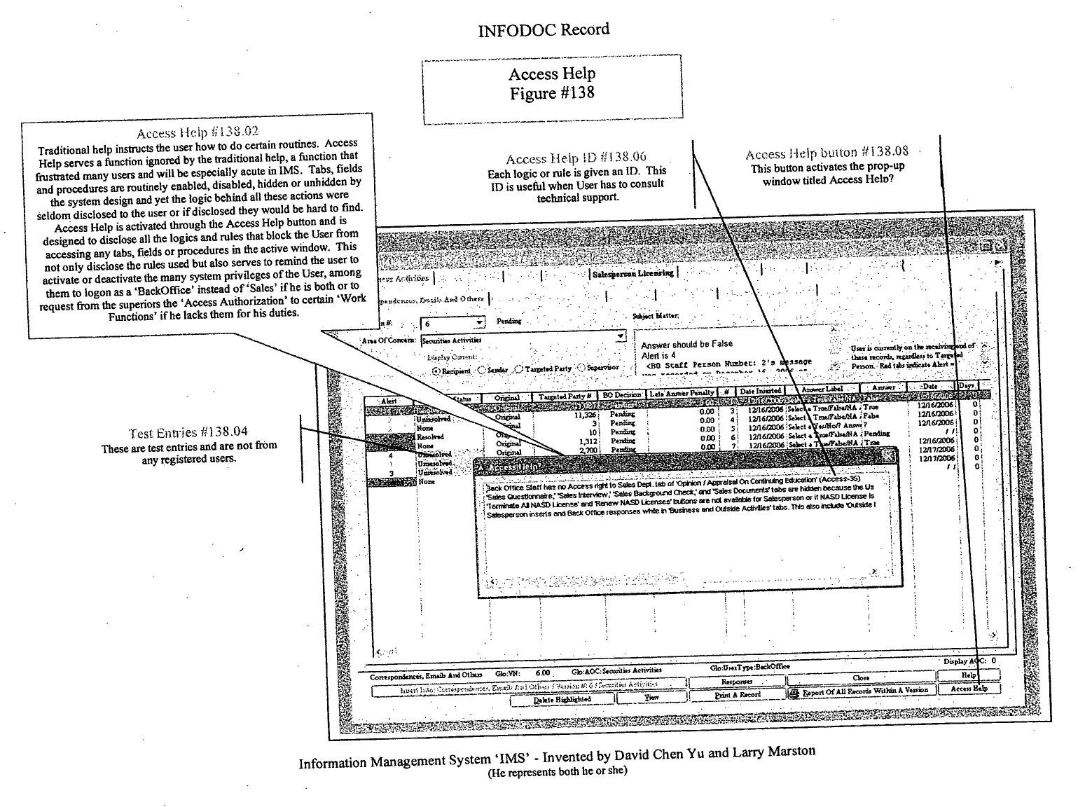

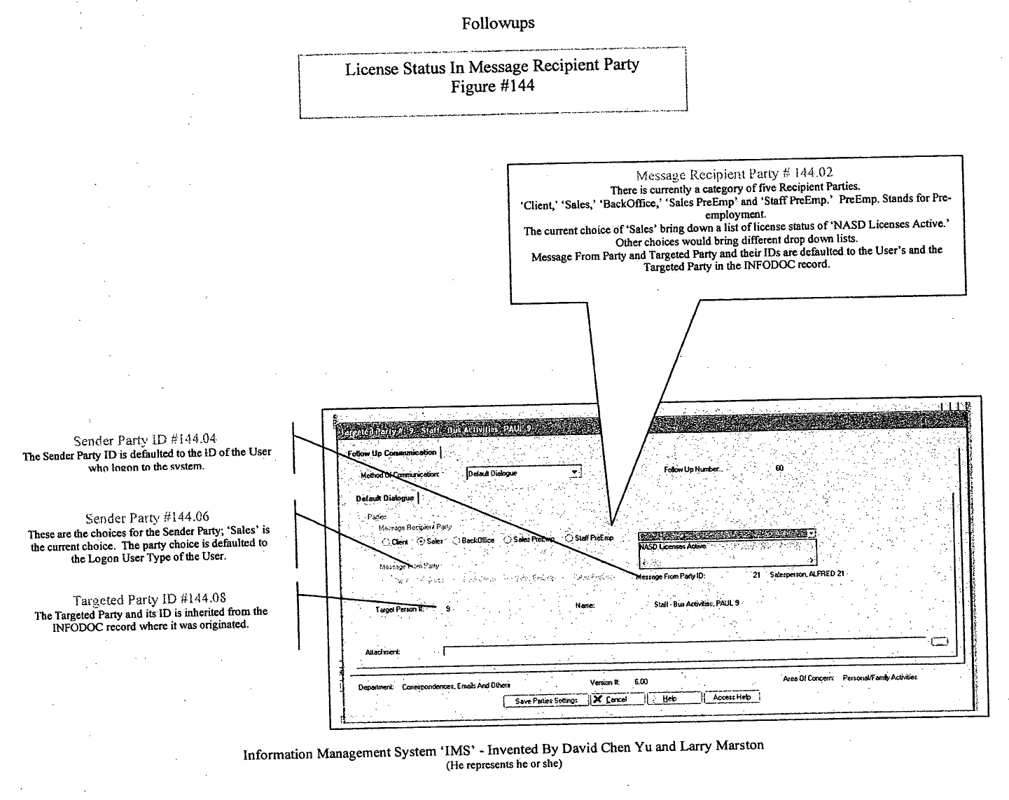

Tokens (FIG. 105A.14)
(See FIG. 137.04) Tokens are variables representing field values from records at run time. By the use of tokens, the user, at run time, can insert field values from each Recipient's personal or account records into the Subject Matter (FIG. 101.12) and other fields of the InFoDoc record (FIG. 101.10). Tokens are available to all SMMS Library Programs (FIG. 102B.06, 102B.08 & 102B.12), Form Library Programs (FIG. 102B.10), Manual Entry (FIG. 102A.02 & 102C.02) and certain letter and reports. Before using tokens, the information referred to by the tokens such as the name, address, etc . . . of the Recipient must first entered into COMREC, which would then be able to transfer them onto the records by the tokens during run time.
   Periodic Procedures Program (FIG. 102B.12, see also FIG. 143-FIG. 145):

These programs use events triggered by the passage of a specific time period. Periods are seconds, minutes, daily, weekly, semi-monthly, monthly, quarterly, semi-annually and annually (See Frequency and Vacations FIG. 102B.14). Upon arrival of the beginning of the period, a procedure is activated by criteria pre-selected by a user. In addition to procedures in ComRec, the Periodic Procedures Program can also trigger actions in procedures in SMMS. Some of the actions are to select a preset record from the SMMS Library Program and insert it into the InFoDoc records of the designated Recipient(s) (both on a One to One or One to Many bases). Example of one-to-one and on the ‘seconds’ period is the redirection of incoming Emails. A one-to-many example would be the Annual Privacy Disclosure that is to be mailed to all active customer accounts. Designated Recipients are Recipients who meet the conditions of the preset Filters. The purpose of this Procedure is to automate the repetitive nature of inserts into SMMS (FIG. 101.10) and other parts of ComRec and to ensure that work, followups and Supervisory functions are performed on a timely manner. In cases of failure, management can ascertain the responsibilities and locate points of failure. Filters and Tokens are available.

Frequency and Vacations (FIG. 102B.14, see also FIG. 105A.12)
To ensure the insertions do not fall on a Saturday and Sunday and any of the public holidays or on any other designate non-working days for the Firm. COMREC provides the Frequency and Vacations program to calculate the activation date and time for the frequency but take into consideration of weekends and designated vacations for this Procedure.

### Form Library Program

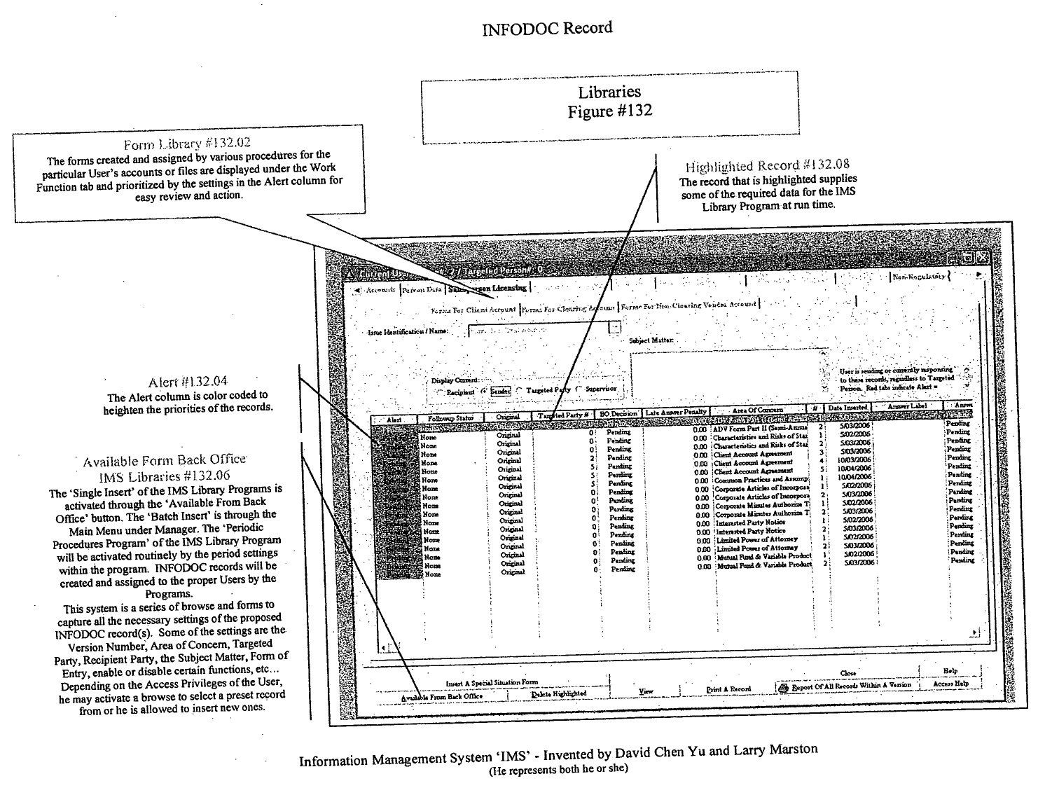

Form Library Program (FIG. 102B.10, see also FIG. 131-FIG. 132): The Form Library Programs and their activation conditions must be preset by users. Forms to be inserted into SMMS (FIG. 101.10) can be triggered by specific events such as the opening of a new customer account or the application of a new hiring of a salesperson or staff. Filters such as those used in SMMS Library Programs are not needed since the program is only activated by conditions. Tokens (FIG. 105.18) are provided. Certain information such as the name, address, etc . . . of the Recipient must first enter into COMREC, which would then be transferred onto the Form by the Tokens at run time. Recipients are usually also the Targeted Party. After the insertion of the forms, Supervisory actions are required to update the Form Stages (FIG. 105A.08) and to approve or disapprove the final completed forms. Supervisory actions also affect other area of ComRec, such as the Approval Stage of an Account or a new hire.

Form Stages (FIG. 105A.08)
Forms activated are managed through the ‘Form Stages’ (FIG. 105A.08). Form Stages are ‘Not Ready, Form Not Printed,’ ‘Not Ready, Form Printed,’ ‘Ready For Back Office, Electronic Form Only,’ ‘Ready For Back Office, Physical Form Submitted,’ ‘Resubmit, Information Incomplete,’ ‘Awaiting Physical Form,’ ‘Awaiting Supervisor Approval,’ ‘Form Approved,’ and ‘Form Rejected For Cause.’ Only a Supervisor (FIG. 100B.28) can approve a form.

Form Category (FIG. 105A.10)
Form Categories are used to divide forms into: All account (i.e. accounts with firm), Account Type in List (the ‘Account Type’ that was defined in ComRec triggers ‘Account Type in List.’), Special Situations (Example of ‘Special Situations’ is ‘Power of Attorney’ form) and forms for certain category of vendors.

### Continuing Education (CE)

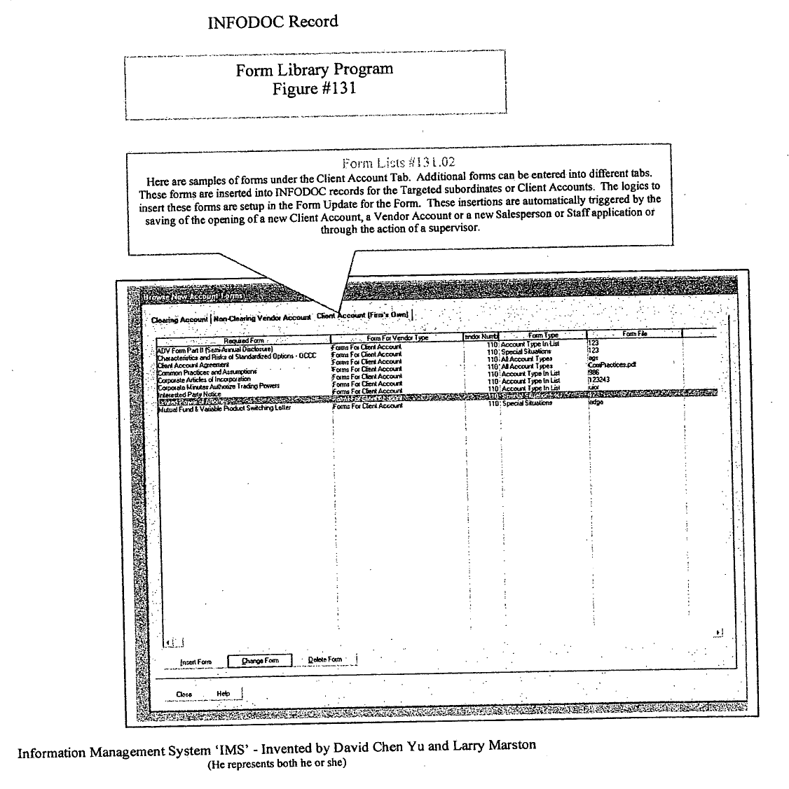

Continuing Education (CE) (FIG. 102A.12, see also FIG. 130): Updates to CE are done manually in the SRO records of the Registrant, and then the CE data are updated to the SMMS by the procedure. Preset requirements entries control how the CE is implemented. Preset requirements are established by the SRO (Self-Regulatory Organization) and Government Agencies. SMMS generates Supervisory Messages.

(FIG. 102A.20) for the CE updates in InFoDoc records. CE Window expiration notices can be generated on a timely basis through the Periodic Procedures Program (FIG. 102B.12). Authority to transact is affected. Non-compliance can result in license ‘Suspension.’

### Licensing

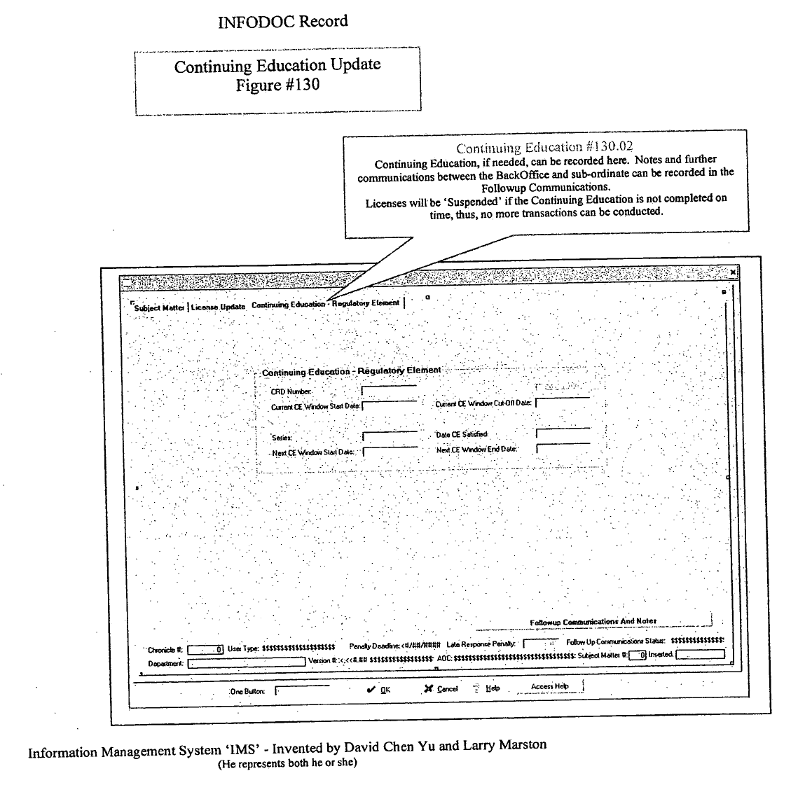

Licensing (FIG. 102A.18, see also FIG. 129): Similar to the Form Program that record insertions are triggered by specific events, new licensing can be triggered by a new licensee. However, updates are done manually in the Licensing record. Licensing data are updated to the InFoDoc file. Licensing data affect whether the Salesperson can receive commission, commission would be on hold or he is barred from transacting. License termination notice can be structured in Periodic Procedures Program (FIG. 102B.12) to alert a Recipient of his pending license termination. SMMS generates Supervisory Message (FIG. 102A.20) in the InFoDoc and Followup records. License expiration notices sending can be scheduled on a periodic basis (Periodic Procedures Program # 102B.12). Authority to transact is terminated when relevant license expired.

### Supervisory Messages

Supervisory Messages (FIG. 102A.20): Triggered by preset conditions, mostly predefined by users, ComRec and SMMS generate messages in InFoDoc targeting a specific Targeted Party (FIG. 104A.08) ID, usually a subordinate staff, a salesperson or an Account Participant, addressed to the Supervisory Staff (Recipient Party, FIG. 104A.14), requesting a review, to approve, to stop certain event, or just a notice to the supervisors. Supervisory response is expected and the Approval or Disapproval will activate certain predefined system actions in addition to further supervisory investigations. Actions such as changing the transacting privileges of a Salesperson, a Participant, his Accounts, a Staff's Work Function Authorizations (FIG. 100B.20), etc . . .

### System Messages

System Messages (FIG. 102A.22): Triggered by preset conditions, ComRec as well as SMMS generate messages to record the occurrence of certain record and field events. Events such as the ID Number of the individual that inserted the record, modified its contents, instructions made, made a request, approved or disapproved a request, appraises another, etc . . . The purpose of the System Messages is to create a chronology of the history of system actions triggered by users. It should supplement other entries to SMMS to present a more complete picture of events in case of disputes.

### Followup Propagate Programs (FIG. 102C)

### Followup Communications Status (FIG. 105B.06)

There are three different statuses to represent the opinion of the parties in Followup Communications (party statues):
1. None. This is the default status for the Recipient. This status represents that the party has no opinion on the status of the message.
2. Unresolved. This is the default status for the Sender. It means that the followup issue is not resolved.
3. Resolved. This closes the Attach To Original Followup. It means that the issue in the messages has been resolved.

These party statuses will be translated into the Status for the Followup.
1. If both the Sender and Recipient have ‘NONE’ status, then the Followup Status is ‘NONE.’
2. If either one has ‘Unresolved’ then the Followup Status is ‘Unresolved.’
3. If both parties have ‘Resolved’ then the Followup Status is ‘Resolved.’
4. If one party is ‘Resolved’ and the other party is ‘NONE’ then the Followup Status is ‘Resolved.’

The Followup Statuses affect the Color Codes of the ‘Followup Communications And Notes’ button (FIG. 141.04) and the availability of the ‘Attach A Message To The Highlighted’ button (FIG. 151.08) in the Followup Browse.

### Manual Entry INTO Followup Record

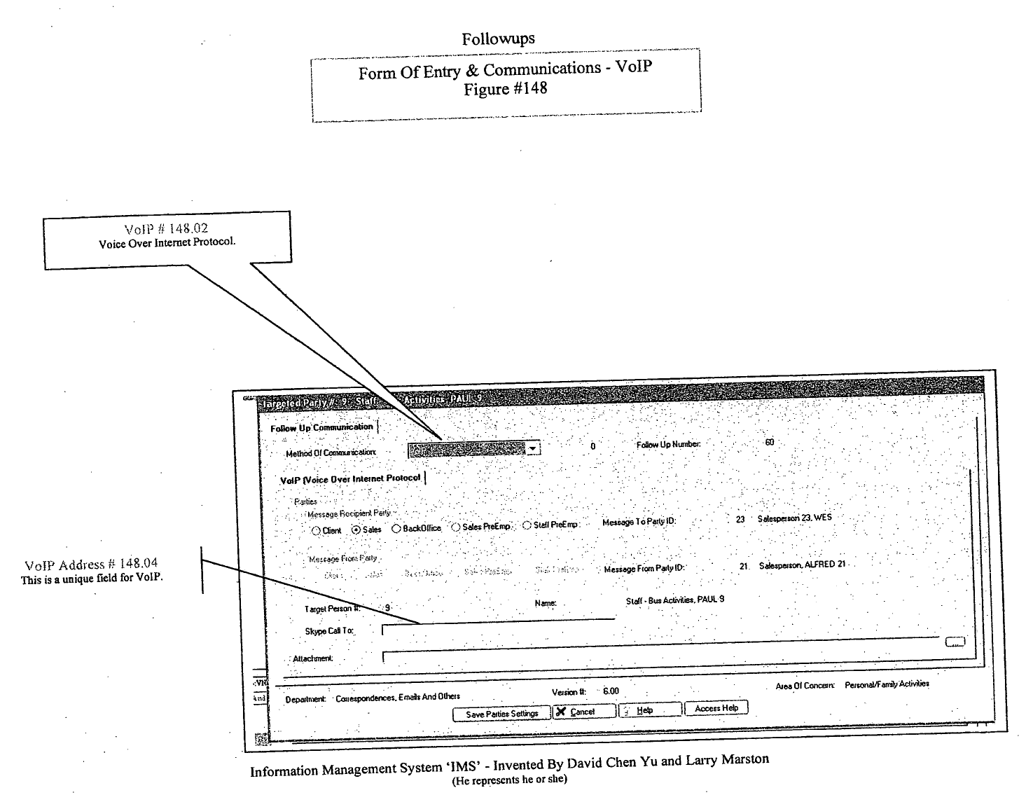

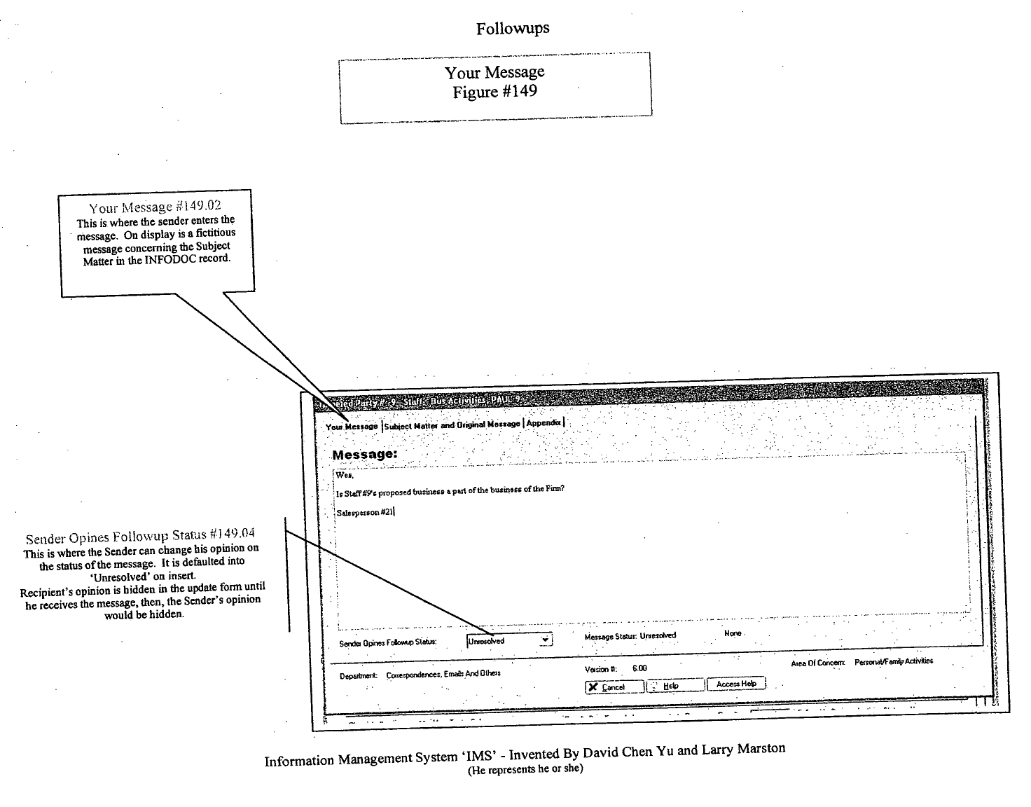

Manual Entry Into Followup Record (FIG. 102C.02, see also FIG. 140-156): Followups can be inserted from the InFoDoc record (FIG. 101.10, FIG. 141.02). To insert a Followup (FIG. 101.14 & FIG. 101.16), select the ‘Followup Communications and Notes’ button (FIG. 141.02) in the Form (InFoDoc record, FIG. 100.10). This will call up the browse for ‘Followups On A Subject Matter.’ (FIG. 142) This is where the user can select to enter ‘Insert A New Message’ or if available ‘Attach A Message To Highlighted’ (FIG. 151.08). Sender Party (FIG. 104B.04) is defaulted to the current user (FIG. 107.14) and Targeted (FIG. 104B.02) Party is defaulted to the Targeted Party (FIG. 104A.02) of the InFoDoc record (FIG. 101.10). The Sender (FIG. 104B.04) must select the Recipient Party (FIG. 104B.16, 144.02) and Recipient Party ID (FIG. 104B.16, 145.02). He must also select the Form of Entry and Communication (FIG. 143), such as Default Dialogue, Email (FIG. 147), VoIP (FIG. 148), IM, Telephone Calls, Meeting Minutes or Private Notes. Late Answer Penalty (FIG. 105.20, FIG. 108.10, 111, 141.08) would be defaulted to the same amount and to be activated after the same number of days as in IFODOC (FIG. 101.10). The resolution of the ‘Original’ Followup is controlled by the Followup Communications Status (FIG. 141.10).

### System Messages to Followups

System Messages To Followups (FIG. 102C.06): System Messages for actions triggered in InFoDoc records (FIG. 101.10) are recorded in the Followups (FIG. 101.14).

### InFoDoc Form of Entry (FIG. 103A & FIG. 103B)

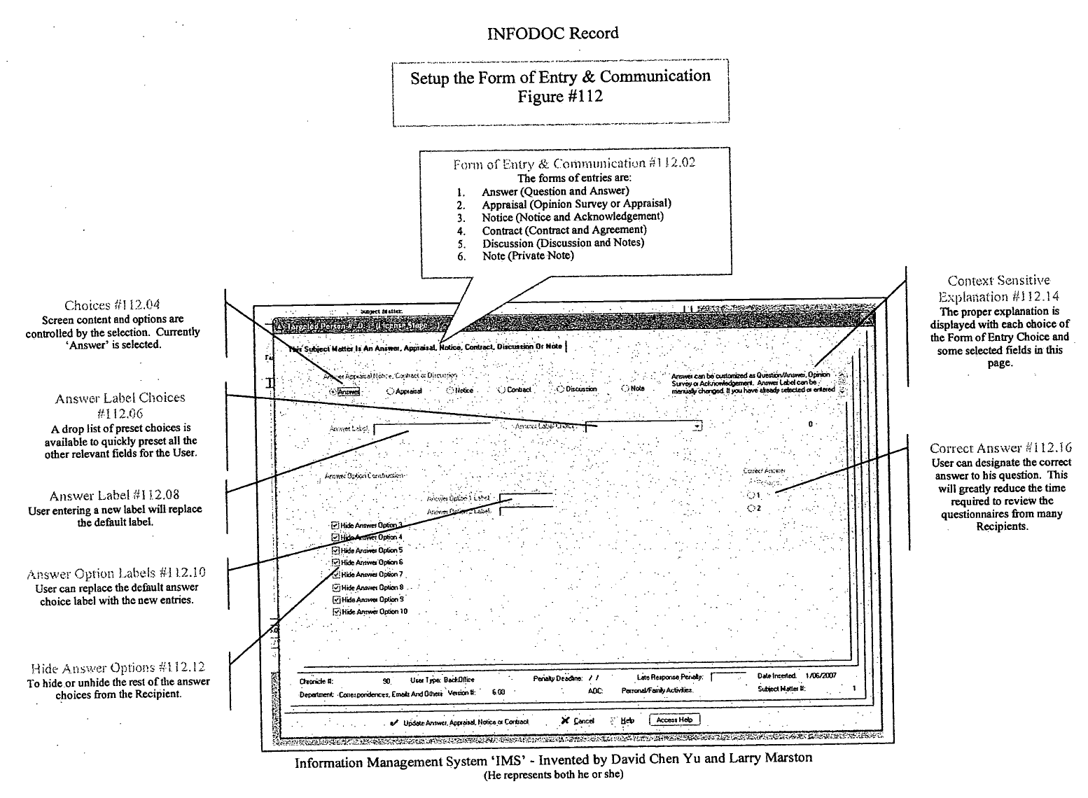

Question/Answer (FIG. 103A.02, see also FIG. 112-FIG. 116)

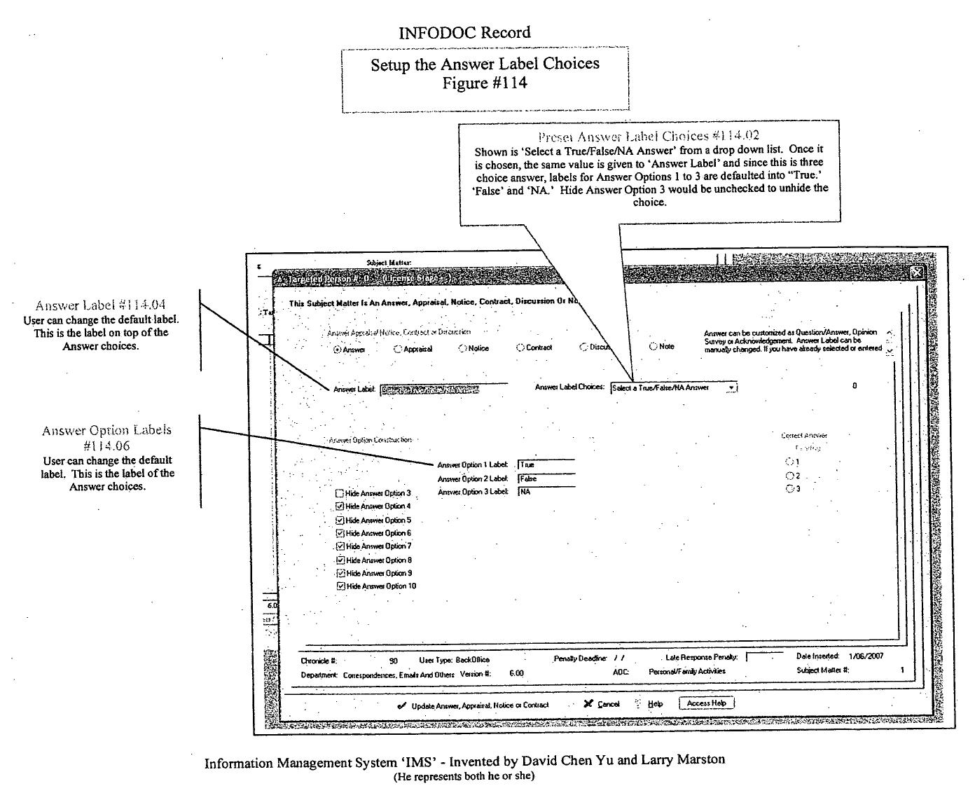

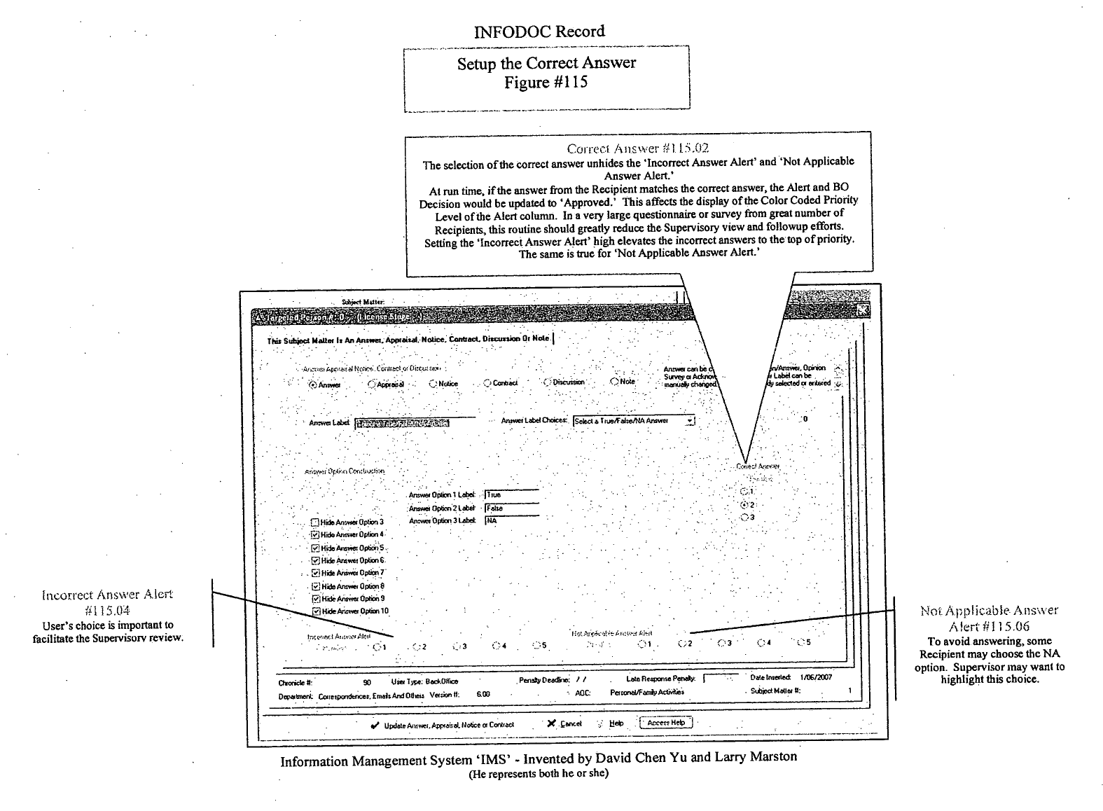

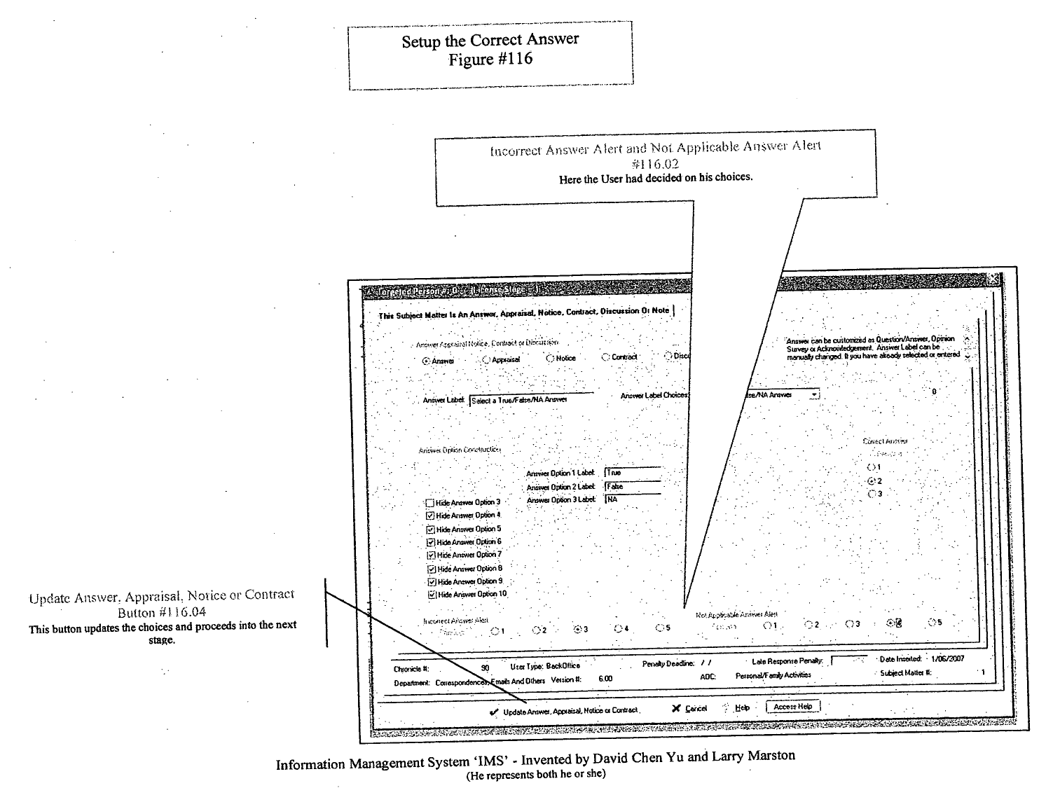

Sometimes referred to as ‘Answer.’Form of Entry can be customized: Number of answer choices (FIG. 112.06); Labels for the answer and their choices (FIG. 112.06-FIG. 114); Designate a correct answer (FIG. 112.16); set Alert levels for incorrect answer choice (FIG. 115.04) and N/A choice (FIG. 115.06 & FIG. 116.02). Response is expected. Non-BackOffice Recipient can check ‘True’ or ‘False’ on ‘Back Office Instruction Is Acceptable’ (FIG. 105A.06) after all the Followup discussions. He is expected to appraise (FIG. 105A.04) the BackOffice on the request. Alert levels (FIG. 105A.02) can be preset by user based on whether the Answer is correct or N/A.

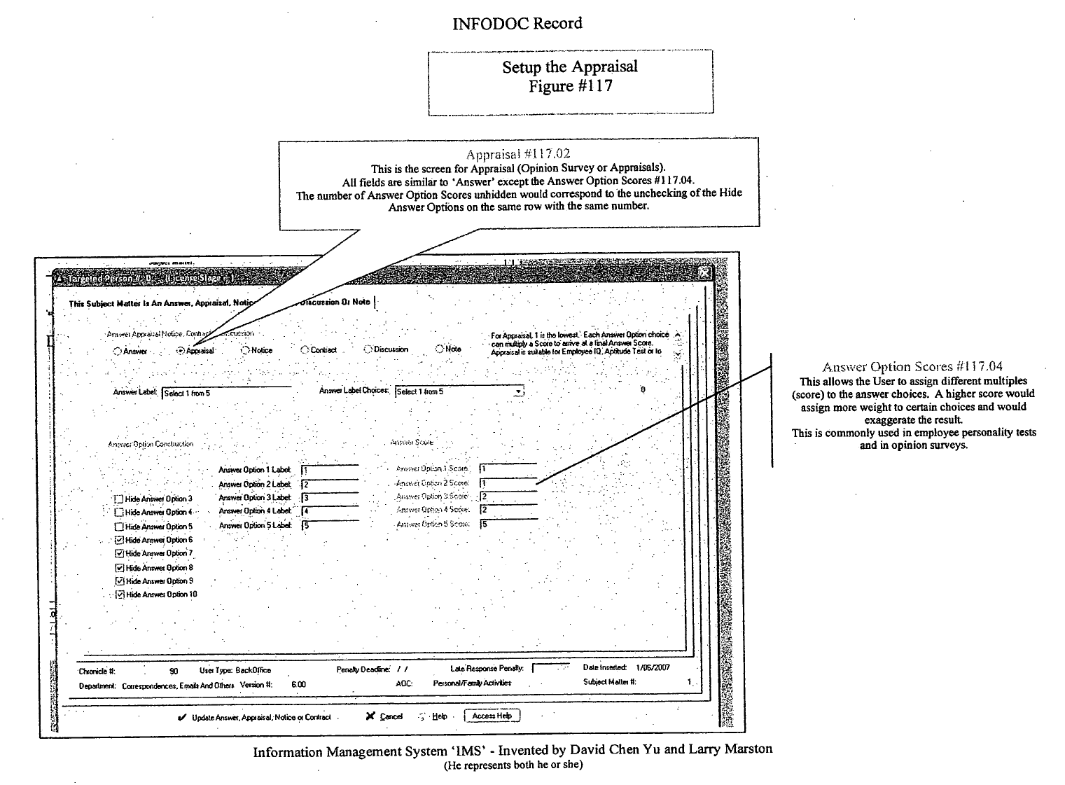

Opinion Survey/Appraisal (FIG. 103A.04, see also FIG. 117)

Sometimes referred to as ‘Appraisal.’Form of Entry can be customized: Number of answer choices; Labels for the answer and their choices; Assign a separate Score (weight) (FIG. 117.04) for each answer choice. Response is expected.

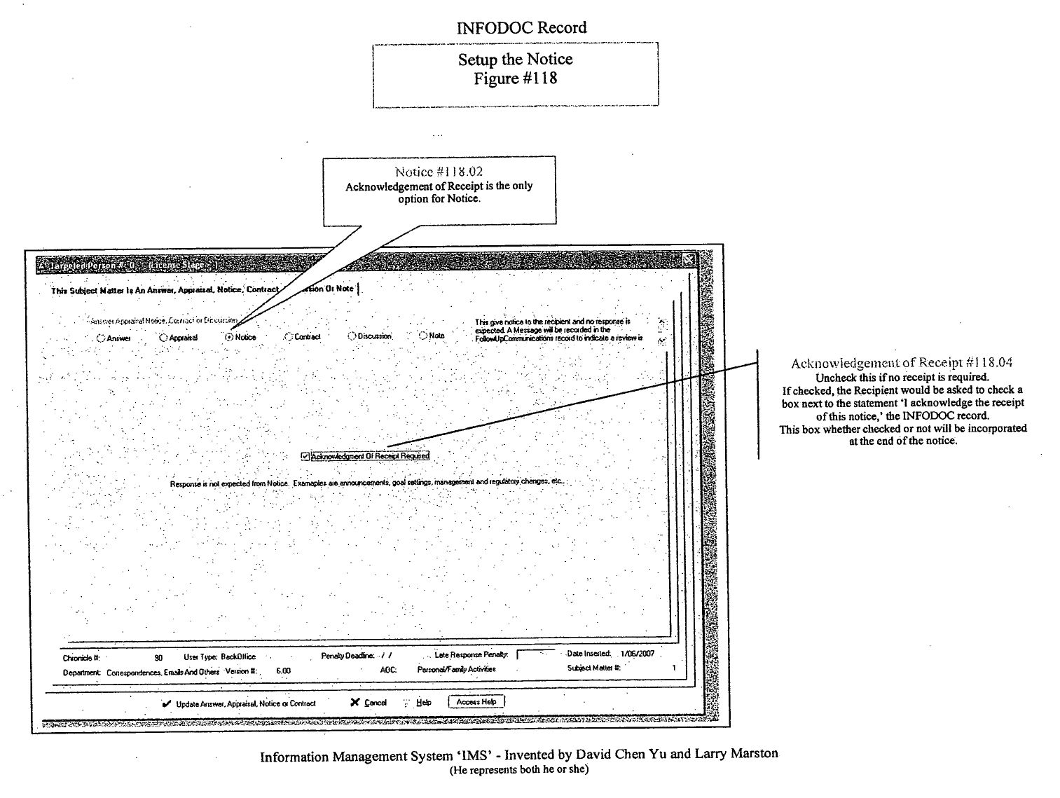

Notice/Acknowledgement (FIG. 103A.06, see also FIG. 118)

Sometimes referred to as ‘Notice.’ No response is expected except an optional Receipt Acknowledgement. Acknowledgement Check box is provided (FIG. 118.04).

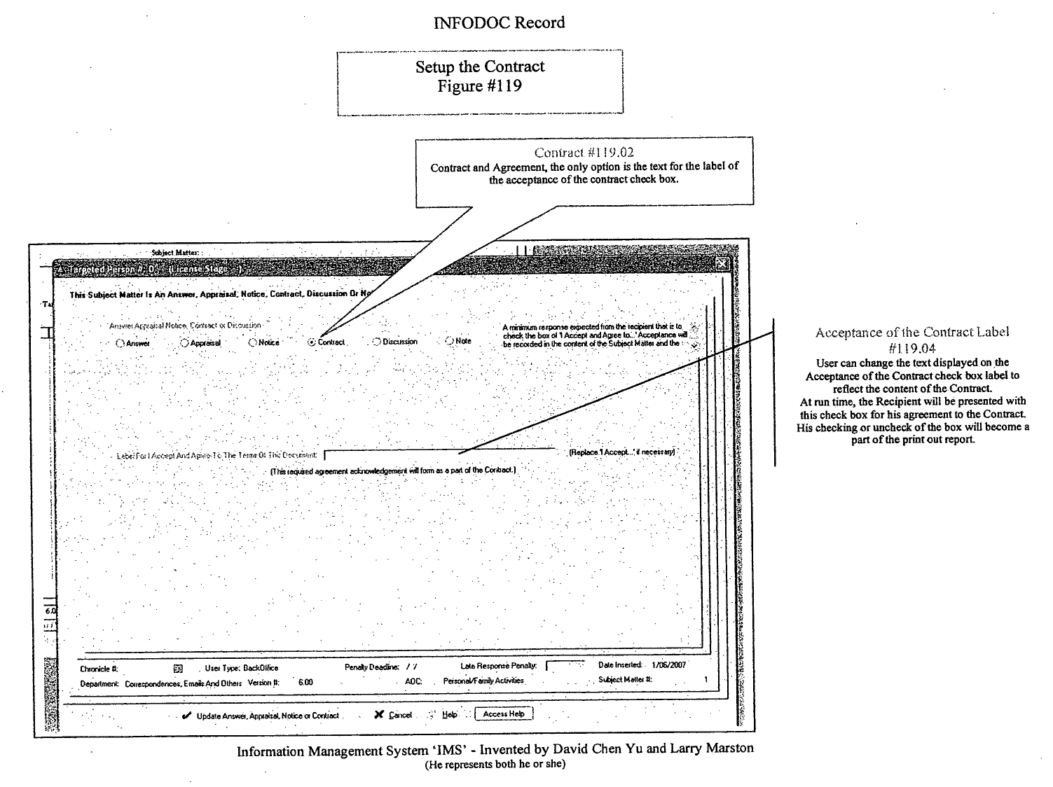

Contract/Agreement (FIG. 103A.08, see also FIG. 119)

Sometimes referred to as ‘Contract.’ Recipient's Agreement to the terms is expected. Agreement Check box is provided (FIG. 119.04). Form Stages is provided for forms such as application and related forms.

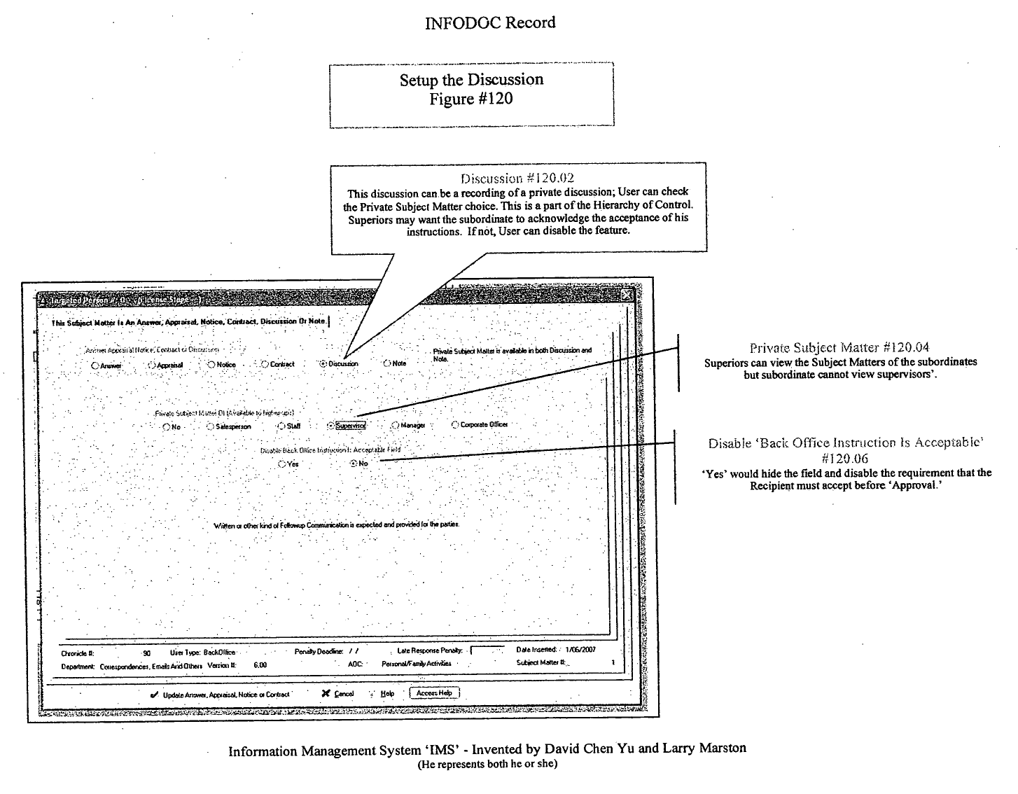

Discussion/Meeting Minutes (FIG. 103A.14, see also FIG. 120)

Sometimes referred to as ‘Discussion.’ Private Note feature (FIG. 100B.26, FIG. 120.04) is available but defaulted to ‘No.’ Optional to use the ‘Disable the BackOffice Instruction Is Acceptable’ (FIG. 120.06) requirement.

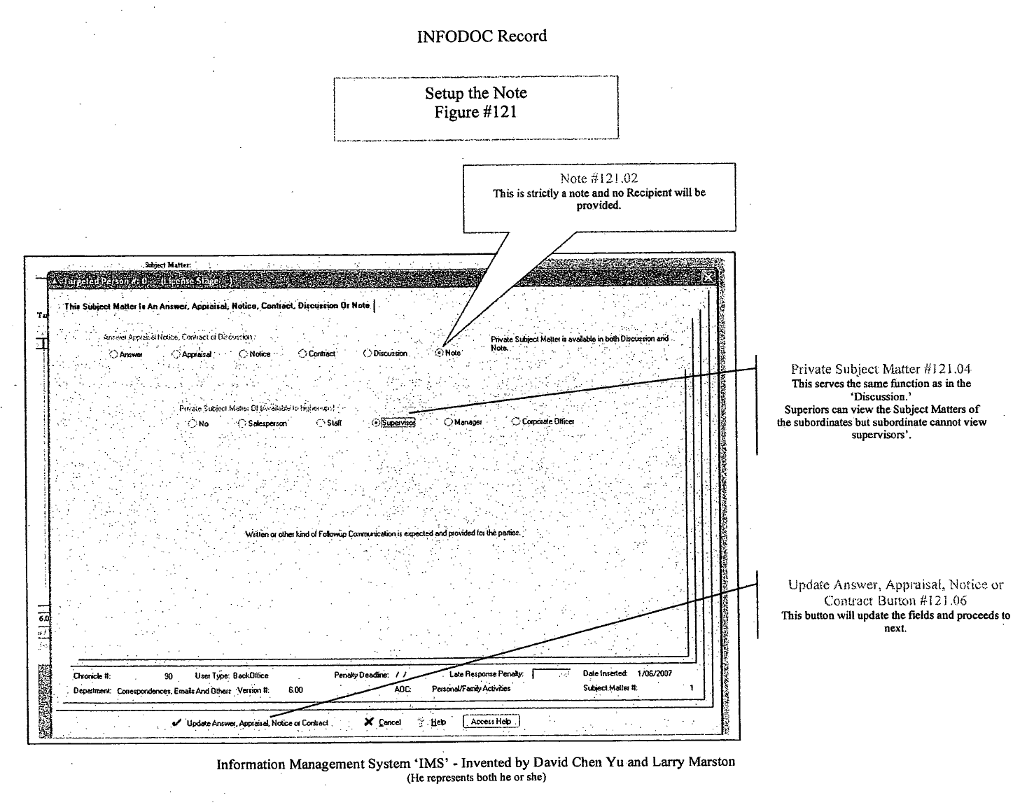

Private Note (FIG. 103A.16, see also FIG. 121)

Sometimes referred to as ‘Note.’ Private Note feature (FIG. 100B.26, FIG. 121.04) is available but defaulted to ‘No.’ Private Note levels are ‘Salesperson,’ ‘Staff,’ ‘Supervisor,’ ‘Manager’ and ‘Corporate Officer.’ Higher ups can view notes in lower levels. Defaulted to disable the BackOffice Instruction Is Acceptable requirement.

### Followup—Form of Entry & Communication (FIG. 103B)

The benefit of integrating all popular forms of communications into Followups is the ease of retrievals, allows examiner to trace and audit the actions taken and view the events chronologically on each Subject Matter and its Followups and the ease for a Superior to assign duties, ascertain performances and responsibilities.

Default Dialogue (FIG. 103B.02, see also FIG. 143.04)

Communicate through the Followup records of the SMMS system by entering data directly into the data base program.

Email (FIG. 103B.04, see also FIGS. 143 & 147)

Communicate through an outside Email server. All Emails are originated and recorded in

Followup records. All incoming Emails are tagged to the original outgoing email. Unsolicited Emails with unknown Email addresses would be assigned to ‘Don't Know Which Department.’

VoIP (FIG. 103B.06, see also FIGS. 143 & 148)

Outgoing Voice Over Internet Protocol (‘VoIP’) would be recorded in the proper Followup records. User would have to assign the Incoming VoIP to its proper record.

Private Note And Highlight (FIG. 103B.08, see also FIG. 143)

It has similar Note features as in those available in InFoDoc record. It offers the ability to insert this Note into a particular date to Highlight or summarize what is to follow.

Meeting Minutes (FIG. 103B.18, see also FIG. 143)

Similar to Discussion in InFoDoc record but without the Private Note feature since this could be a Followup to the Private Note in InFoDoc record.

IM (FIG. 103B.20, see also FIG. 143)

Instant Messages between two parties can be recorded and categorized in Followup Records.

### InFoDoc Parties (FIG. 104A)

Parties to the InFoDoc record are easily recognizable with the exception of Targeted Party.

### Targeted Party (FIG. 104A.02)

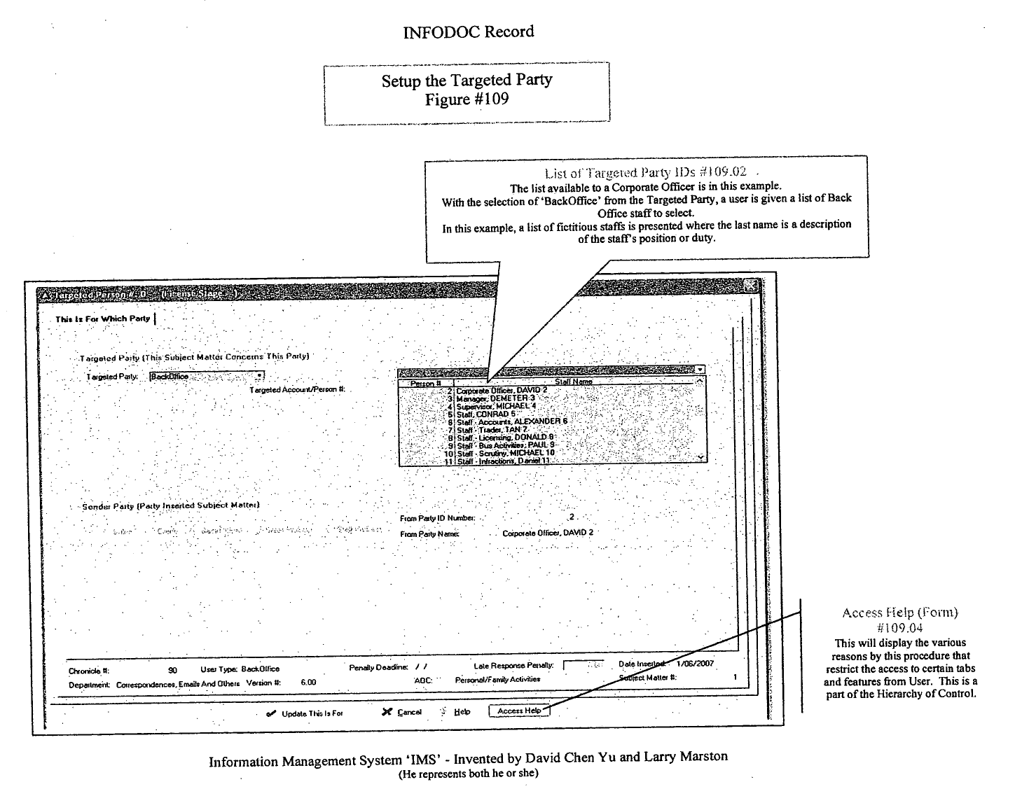

This is the party that is the focus of the discussion. (See FIG. 108.02 & FIG. 109.02) Targeted party will be the same in the InFoDoc record (FIG. 101.10) as well as in all its Followups (FIG. 101.14-101.16, see also FIG. 144.08) because it is linked to the same Subject Matter (FIG. 101.12).

### Targeted Party ID Number (FIG. 104A.08)

Each Targeted Party is identified by a unique ID number (FIG. 109.02). This ID number is defaulted to his Person Number. In the case of an account selected as the Targeted Party, the ID number will be the account number.

### Sender Party (FIG. 104A.04)

(See FIGS. 107.02, 107.14, 108.06) He sets up an InFoDoc record (FIG. 101.10) sends and requests (FIG. 108-FIG. 125) an answer (FIG. 112-FIG. 116), simply sends a notice and requires no response or requests an acknowledgement (FIG. 118), or requests an agreement (FIG. 119) from the Recipient (FIG. 104A.08) or just record a note (as a Private Note in Discussion (FIG. 120) & Note (FIG. 121)) for himself. A BackOffice Sender can set Late Answer Penalty (FIG. 105A.20) and disable Attachment and certain Follow-up features (FIG. 111). Upon receipt of a response, the Sender if he is from the BackOffice can Approve, Disapprove or select a number of actions (FIG. 125.04) and modify the Alert level (FIG. 105.02, FIG. 125.06). If approved, he must appraise the Recipient (FIG. 105A.04).

### Sender Party Id Number (FIG. 104A.06)

A unique ID number (FIG. 108.06) identifies each Sender Party. This ID number is defaulted to his Person Number.

### Recipient Party (FIG. 104A.12)

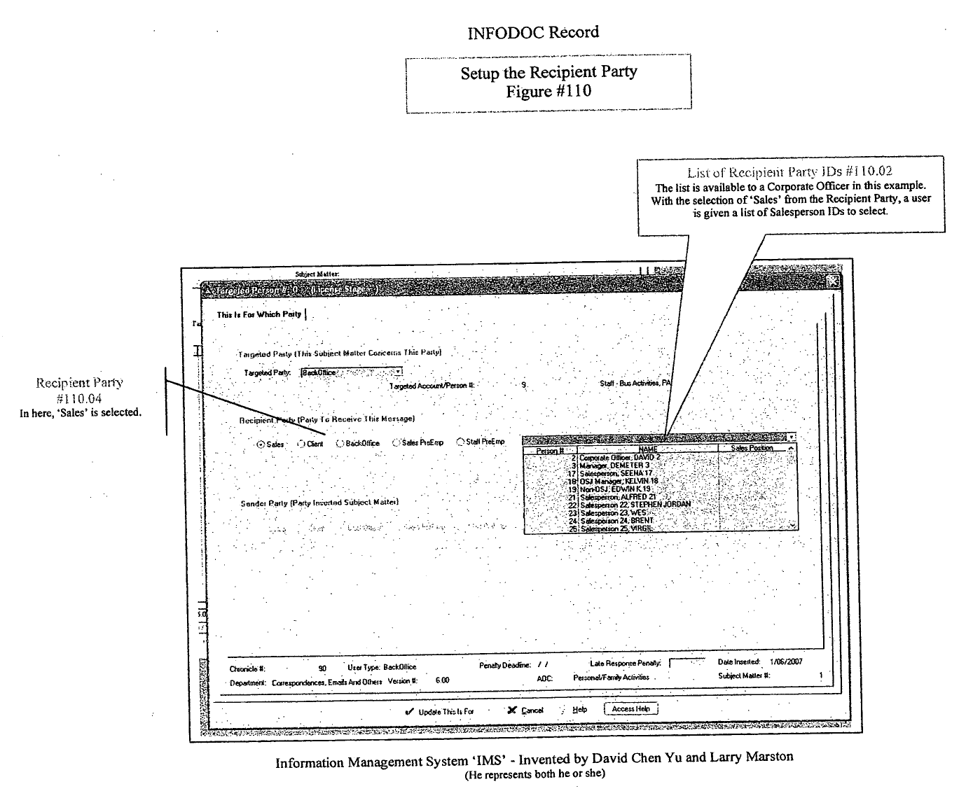

Based on the type of request, the Recipient (see FIG. 110) can answer (FIG. 127.02), select a preference, accept the instructions (FIG. 105A.06), appraises the Sender (FIG. 105A.04).

Further discussions are conducted in the Follow-up system (FIG. 100.18 & FIG. 100.20). Back Office Recipient can set Alert Level (FIG. 105A.02, see also FIG. 125.06), approve the request and appraises (FIG. 105A.04) the Sender (FIG. 104A.02).

### Recipient Party ID Number (FIG. 104A.14)

A unique ID number (FIG. 110.02) identifies each Recipient Party. This ID number is defaulted to his Person Number.

Eligible to be a Party
Sender and Recipient Party: Any of the individuals from Sales, Customer Account Participants as well as any of the staff from the BackOffice. Firm IT Staff, Outside Auditors, Examiner and Guests can have View privilege only.
Targeted Party Any of the Client and Vendor Accounts in addition to the Sender and Recipient Parties above.
The availability of the choices of Targeted and Recipient Party IDs are restricted or reduced based on the Access Privileges (FIGS. 100A & 100B) and the User Type (FIG. 100A.08) (Position) to ensure a structured hierarchy of controls (FIG. 100A & 100B) by the Firm, i.e. A Salesperson can only send to his clients and not to others.

### Followup Parties (FIG. 104B)

Similar to InFoDoc's Subject Matter, Followup Message is the anchor field for the

Followup records.

### Followup Message (FIG. 104B.14)

It should be the additional discussions on and different then the Subject Matter that it is following up on. It should be focused on one subject or event instead of a series of matters. It would be difficult to follow-up on if the message were overly complicated. (See FIG. 107.18, FIG. 122-FIG. 125 & FIG. 150.02).

### Targeted Party (FIG. 104B.02)

This is the party that is the focus of the discussion. (See FIG. 108.02 & FIG. 109.02) Targeted party is the same in the InFoDoc record (FIG. 101.10) as well as in all its Followups (FIG. 101.14 & 101.16, see also FIG. 144.08) because it is linked to the same Subject Matter (FIG. 101.12).

### Targeted Party ID Number (FIG. 104B.08)

Each Targeted Party is identified by a unique ID number (FIG. 144.08). This ID number is defaulted to his Person Number. In the case of an account as the Targeted Party, the ID number is the account number.

### Message Sender Party (FIG. 104B.04)

It can be an individual from any of the pre-defined eligible parties including but not limited to the Sender and Recipient of the InFoDoc record (see FIG. 144.04 & FIG. 144.06).

### Message Sender Party ID Number (FIG. 104B.06)

Each Sender Party is identified by a unique ID number (FIG. 144.04). This ID number is defaulted to his Person Number.

### Message Recipient Party (FIG. 104B.16)

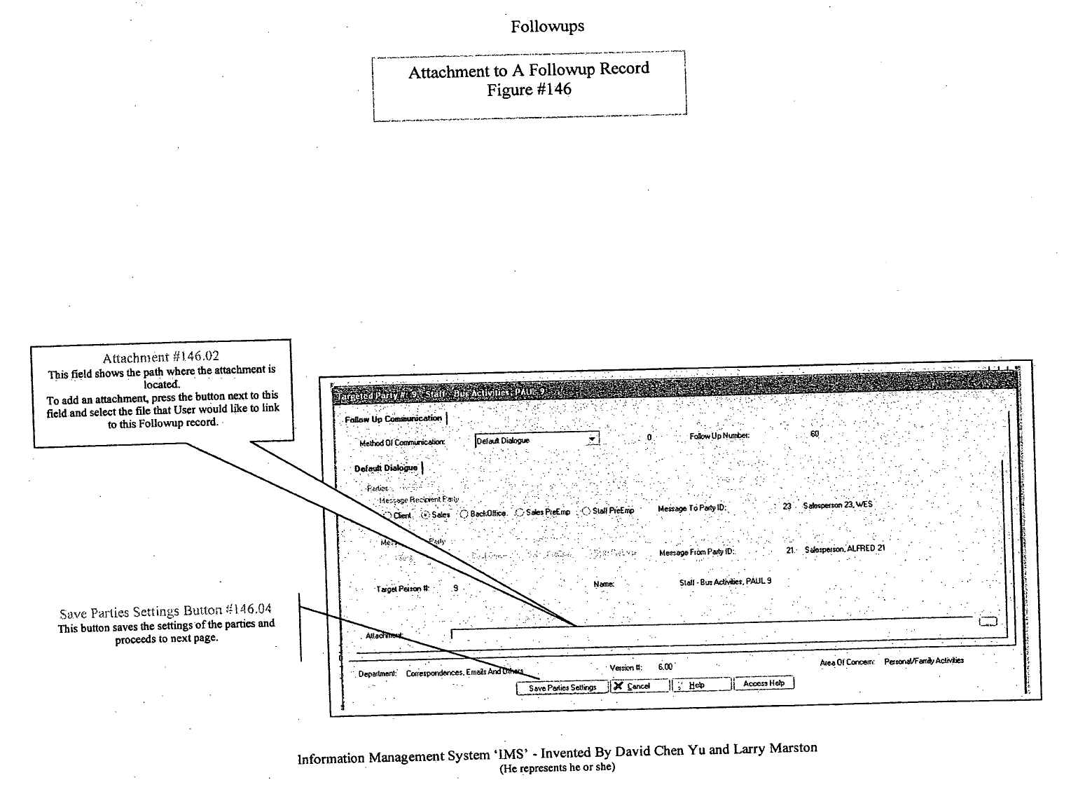

It can be an individual from any of the pre-defined eligible parties including but not limited to the Sender and the Recipient of the InFoDoc record. (See FIG. 144 & FIG. 145)

### Message Recipient Party ID Number (FIG. 104B.18)

Each Recipient Party is identified by a unique ID number (FIG. 145.02). This ID number is defaulted to his Person Number.

While the invention is susceptible to various modifications and alternative forms; specific embodiments thereof have been shown by way of example in the drawings and are herein described in detail. It should be understood, however, that the description herein of specific embodiments is not intended to limit the invention to the particular forms disclosed.

1. A method for managing information, comprising the steps of:
a. Creating a Hierarchy of Control for access authorizations;
b. Creating an InFoDoc record from a plurality of formats;
c. Creating the InFoDoc record between a plurality of parties;
d. Entering the InFoDoc record into a InFoDoc file using the plurality of formats;
e. Managing the InFoDoc records using the plurality of formats;
f. Creating Followup Messages based upon said InFoDoc record from the plurality of formats;
g. Creating Followup Messages based upon said InFoDoc record between the plurality of parties;
h. Entering Followup Messages in a Followup file using the plurality of formats; and
i. Managing the Followup Messages using the plurality of formats

2. A method for managing information as in claim 1a, wherein said Hierarchy of Control includes the use of User Types of Client, Sales, BackOffice, Examiner or PreEmployment and their associated User Access Classes and Access Privileges into corresponding Work Functions under Departments, wherein the Access Privileges of the User Type restricts the insertion, change, delete and view functions, and restricts the authority to approve, disapprove, comment on, request response from a predetermined Alert level on any of the InFoDoc record and restricts the generation of reports on any or a collection of InFoDoc records created.

3. A method for managing information as in claim 1b, wherein said plurality of formats include at least one of a Manual Entry, a SMMS Library Single Insert Program, a SMMS Library Batch Insert Program, a Periodic Procedures Program, a Form Library Program, a Continuing Education Program, a Salesperson and Supervisor Licensing Program, a Supervisory Message or a System Message. Preset Messages, Filters, Tokens and Frequency and Vacation Designation features are available to enhance the record creation experiences.

4. A method for managing information as in claim 1c, wherein said plurality of formats on the InFoDoc record include a Targeted Party and its Targeted Party ID Number, a Sender Party and its Sender Party ID Number and a Recipient Party and its Recipient Party ID Number.

5. A method for managing information as in claim 1d, wherein said plurality of formats on the InFoDoc record include at least one of a Question/Answer, an Opinion Survey/Appraisal, a Notice/Acknowledgement, a Contract/Agreement, a Discussion/Meeting Minutes or a Private Note.

6. A method for managing information as in claim 1e, wherein said plurality of formats on the InFoDoc record include record Alert levels and their relations to Back Office Decisions, Appraisal of Sender and Recipient, a Salesperson's acknowledgement of the Back Office Instruction Is Acceptable, Form Stages to manage the form completion, available Form Categories, Preset Messages, Late Answer Penalties to be imposed on Recipient Party, Attachment of documents and a Color Coded presentation system to manager record Priorities for the Current User Party.

7. A method for managing information as in claim 1f, wherein said a plurality of formats on the Followup Message include at least one of a Manual Entry, a Preset Message or a System Message.

8. A method for managing information as in claim 1g, wherein said plurality of formats on the Followup Message include a Targeted Party and its Targeted Party ID Number, a Message Sender Party and its Message Sender Party ID Number and a Message Recipient Party and its Message Recipient Party ID Number.

9. A method for managing information as in claim 1h, wherein said plurality of formats on the Followup Message include Default Dialogue, Email, VoIP, Private Note, Highlight Points, Meeting Minutes, and IM (Instant Messages).

10. A method for managing information as in claim 1i, wherein said plurality of formats on said Followup Message include the features of Attach (a Followup record) To Original Followup, Highlight Insert Points in the record browse, Followup Communication Status, Late Answer Penalty, Attachment of documents and Color Coded presentation system to indication record Priorities for the Current User Party.
